(19) United States
(12) Patent Application Publication
(10) Pub. No.: US 2020/0008189 A1
(43) Pub. Date: Jan. 2, 2020

(54) Ultra-Reliability Design for Physical Uplink Control Channel (PUCCH) in 5th Generation (5G) New Radio (NR)

(71) Applicant: Sharp Laboratories of America (SLA), Inc., Vancouver, WA (US)

(72) Inventors: Zhanping Yin, Vancouver, WA (US); Tatsushi Aiba, Vancouver, WA (US); Kazunari Yokomakura, Vancouver, WA (US)

(21) Appl. No.: 16/454,207

(22) Filed: Jun. 27, 2019

Related U.S. Application Data
(63) Continuation of application No. PCT/US2019/039147, filed on Jun. 26, 2019.
(60) Provisional application No. 62/692,291, filed on Jun. 29, 2018.

(51) Int. Cl. H04W 72/04; H04W 76/27; H04L 27/26; H04B 1/713; H04W 76/11; H04L 1/18; H04L 5/00

(52) U.S. Cl. CPC H04W 72/0413; H04W 76/27; H04L 27/2614; H04L 5/0055; H04W 76/11; H04W 72/0446; H04L 1/1819; H04B 1/713

(57) ABSTRACT

A mobile station and base station are presented where RRC messages are used for configuring a number of repetitions in a time domain for a PUCCH format 0. If a first number of repetitions has been previously configured, the UCI is repeatedly transmitted in continuous symbols based on the first number of repetitions. RRC messages can also be used to enable frequency hopping in a frequency domain for the PUCCH format 0, where the number of repetitions in the time domain is applied per hop in the frequency domain. Otherwise, RRC messages may include transmission power parameters whose selection is responsive to the type of RNTI used for scheduling PDSCH communications. A first set of parameters is used if a C-RNTI is used for scheduling the PDSCH, and a second set is used when a RNTI, different from a C-RNTI, is used for scheduling of the PDSCH.

### BACKGROUND OF THE INVENTION

### Field of the Invention

The present disclosure relates generally to communication systems. More specifically, the present disclosure relates to Physical Uplink Control Channel (PUCCH) design for 5th generation (5G) new radio (NR).

### Description of the Related Art

Wireless communication devices have become smaller and more powerful in order to meet consumer needs and to improve portability and convenience. Consumers have become dependent upon wireless communication devices and have come to expect reliable service, expanded areas of coverage, and increased functionality. A wireless communication system may provide communication for a number of wireless communication devices, each of which may be serviced by a base station. A base station may be a device that communicates with wireless communication devices.

In 5G NR, different services can be supported with different Quality of Service (QoS) requirements, e.g. reliability and delay tolerance. For example, enhanced Mobile Broadband (eMBB) is targeted for high data rates, and Ultra-Reliable Low Latency Communications (URLLC) is for ultra-reliability and low latency. To provide ultra-reliability for URLLC traffic, the PUCCH for Uplink Control Information (UCI) feedback should also be enhanced to the same reliability level as the data for URLLC. That is, for URLLC Physical Downlink Shared Channel (PDSCH) transmissions, the Hybrid Automatic Repeat Request Acknowledgement (HARQ-ACK) feedback of a URLLC Downlink (DL) data should have the same reliability requirements as the URLCC data transmission itself.

The current NR PUCCH design is targeted for a Acknowledge (ACK) miss detection probability of 10⁻², and Negative ACK (NACK) to ACK error probability of 10⁻³. Therefore, it would be advantageous if enhancements could be specified to increase the PUCCH reliability for HARQ-ACK feedback of URLLC traffic.

### SUMMARY OF THE INVENTION

Disclosed herein are systems and methods for increasing reliability in Ultra-Reliable Low Latency Communications (URLLC) Physical Uplink Control Channels (PUCCHs). Due to the ultra-low latency requirements, the PUCCH format 0, i.e. the short PUCCH with up to 2 bits of Uplink Control Information (UCI), is more suitable for URLLC data Hybrid Automatic Repeat Request Acknowledge (HARQ-ACK) feedback. In New Radio (NR), PUCCH format 0 is a short PUCCH with 1 or 2 symbols, and is designed for feedback of up to 2 UCI bits. To reduce the error probability of PUCCH format 0, several methods are presented:
Configuring more than one Physical Resource Block (PRB);
Time domain repetition;
Transmit diversity; and,
Different transmit power settings.

The above-mentioned methods can be configured independently or jointly. To provide ultra-reliability for URLLC traffic, the PUCCH for UCI feedback should also be enhanced to the same reliability level as the data for URLLC. Due to the ultra-low latency requirements, the PUCCH format 0, i.e. the short PUCCH with up to 2 bits of UCI, is more suitable for URLLC data HARQ-ACK feedback.

Accordingly, A mobile station is provided with receiving circuitry configured to receive a Radio Resource Control (RRC) message with a first set of transmission power parameters and a second set of transmission power parameters. Transmitting circuitry is configured to transmit UCI using a PUCCH format 0, with the UCI being transmitted based upon either the first set of transmission power parameters or the second set of transmission power parameters. The selection of which parameter is responsive to the type of Radio Network Temporary Identifier (RNTI) used for scheduling physical downline shared channel (PDSCH) communications. The number of bits supported for the UCI using the PUCCH format 0 is either 1 bit or 2 bits and a low-Peak to Average Power Ratio (low-PAPR) sequence is used for the PUCCH format 0.

The mobile station transmitting circuitry transmits using the first set of transmission power parameters for the UCI when a Cell-Radio Network Temporary Identifier (C-RNTI) is used for scheduling the PDSCH. Alternatively, the transmitting circuitry transmits using the second set of transmission power parameters for the UCI when a RNTI, different from a C-RNTI, is used for scheduling of the PDSCH.

Also provided is a base station with transmitting circuitry configured to transmit a RRC message with a first set of transmission power parameters and a second set of transmission power parameters. Receiving circuitry is configured to receive UCI using the PUCCH format 0, with the UCI being received with a power based upon either the first set of transmission power parameters or the second set of transmission power parameters. The selection of which parameter is responsive to the type of RNTI used for the PDSCH communications. The number of bits supported for the UCI using the PUCCH format 0 is either 1 bit or 2 bits, and a low-PAPR sequence is also used for the PUCCH format 0. The receiving circuitry receives the UCI using the first set of transmission power parameters when a C-RNTI is used for scheduling of the PDSCH, or the receiving circuitry receives the UCI using the second set of transmission power parameters when a RNTI, different from a C-RNTI, is used for scheduling of the PDSCH.

In another aspect, the mobile station includes receiving circuitry configured to receive a RRC message including first information used for configuring a number of repetitions in a time domain for the PUCCH format 0. Transmitting circuitry is configured to transmit UCI using the PUCCH format 0. As above, either 1 bit or 2 bits is supported for the UCI using the PUCCH format 0, and a low-PAPR sequence is also used for the PUCCH format 0. If a first number of repetitions has been previously configured, the transmitting circuitry repeatedly transmits the UCI using the PUCCH format 0 in continuous symbols based on the first number of repetitions.

The mobile station the receiving circuitry may also, or alternatively receive a second information used to enable frequency hopping in a frequency domain for the PUCCH format 0. If hopping in the frequency is enabled, the transmitting circuitry transmits the UCI using the PUCCH format 0 with hopping in the frequency domain, where the number of repetitions in the time domain is applied per hop in the frequency domain.

In one aspect of the base station, transmitting circuitry is configured to transmit a RRC message including first information used for configuring a number of repetitions in a time domain for the PUCCH format 0. The receiving circuitry is configured to receive UCI using the PUCCH format 0, where either 1 bit or 2 bits is supported for the UCI using the PUCCH format 0, and a low-PAPR sequence is also used for the PUCCH format 0. If a first number of repetitions has been previously configured, the receiving circuitry repeatedly receives the UCI using the PUCCH format 0 in continuous symbols based on the first number of repetitions.

Alternatively or in addition, the base station transmitting circuitry is configured to transmit a RRC message including second information used for enabling hopping in a frequency domain for the PUCCH format 0. Then, the receiving circuitry, if hopping in the frequency is enabled, receives the UCI using the PUCCH format 0 with hopping in the frequency domain, where the number of repetitions in the time domain is applied per hop in the frequency domain.

Additional details of the above-described communications network UE and methods of improving the reliability of URLLC PUCCH format 0 communications are provided below.

### BRIEF DESCRIPTION OF THE DRAWINGS

FIG. 1 is a block diagram illustrating one implementation of one or more gNBs and one or more UEs in which systems and methods for the improvement of URLLC PUCCH format 0 communications for 5th generation (5G) new radio (NR) may be implemented;

FIG. 2 is a schematic block diagram depicting a UE operating in a wireless communications network;

FIG. 3A is a flowchart illustrating, for a wireless communications network UE, a method for enhanced reliability;

FIG. 3B is a flowchart illustrating a different aspect of the wireless communications network UE method for enhanced reliability;

FIG. 4A is a flowchart illustrating a method for enhanced reliability in a UE comprising a non-transitory memory, with an enhanced PUCCH module residing in the memory and including a sequence of processor executable instructions;

FIG. 4B is a flowchart illustrating an alternate method for improving reliability;

FIG. 5 is a diagram depicting an enhanced PUCCH format 0 with multiple PRB allocations;

FIG. 6 includes diagrams depicting time domain repetition with the use of frequency hopping;

FIGS. 7A through 7D are diagrams depicting URLLC PUCCH Subcarrier Spacing (SCS);

FIG. 8 is a diagram illustrating one example of a resource grid for the downlink;

FIG. 9 is a diagram illustrating one example of a resource grid for the uplink;

FIG. 10 is a diagram illustrating examples of several numerologies;

FIG. 11 is a diagram illustrating examples of subframe structures for the numerologies that are shown in FIG. 10;

FIG. 12 is a diagram illustrating examples of slots and sub-slots;

FIG. 13 is a diagram illustrating examples of scheduling timelines;

FIG. 14 is a diagram illustrating examples of downlink (DL) control channel monitoring regions;

FIG. 15 is a diagram illustrating examples of DL control channel which consists of more than one control channel elements;

FIG. 16 is a diagram illustrating examples of UL control channel structures;

FIG. 17 is a block diagram illustrating one implementation of a gNB;

FIG. 18 is a block diagram illustrating one implementation of a UE;

FIG. 19 illustrates various components that may be utilized in a UE;

FIG. 20 illustrates various components that may be utilized in a gNB;

FIG. 21 is a block diagram illustrating one implementation of a UE in which systems and methods for a long PUCCH design for 5G NR operations may be implemented;

FIG. 22 is a block diagram illustrating one implementation of a gNB in which systems and methods for a long PUCCH design for 5G NR operations may be implemented;

FIG. 23 is a flowchart illustrating a mobile station communication method;

FIG. 24 is a flowchart illustrating a base station communication method;

FIG. 25 is a flowchart illustrating an alternative mobile station communication method; and,

FIG. 26 is a flowchart illustrating an alternative base station communication method.

### DETAILED DESCRIPTION

The 3rd Generation Partnership Project, also referred to as “3GPP,” is a collaboration agreement that aims to define globally applicable technical specifications and technical reports for third and fourth generation wireless communication systems. The 3GPP may define specifications for next generation mobile networks, systems, and devices.

3GPP Long Term Evolution (LTE) is the name given to a project to improve the Universal Mobile Telecommunications System (UMTS) mobile phone or device standard to cope with future requirements. In one aspect, UMTS has been modified to provide support and specification for the Evolved Universal Terrestrial Radio Access (E-UTRA) and Evolved Universal Terrestrial Radio Access Network (E-UTRAN).

At least some aspects of the systems and methods disclosed herein may be described in relation to the 3GPP LTE, LTE-Advanced (LTE-A) and other standards (e.g., 3GPP Releases 8, 9, 10, 11 and/or 12). However, the scope of the present disclosure should not be limited in this regard. At least some aspects of the systems and methods disclosed herein may be utilized in other types of wireless communication systems.

A wireless communication device may be an electronic device used to communicate voice and/or data to a base station, which in turn may communicate with a network of devices (e.g., public switched telephone network (PSTN), the Internet, etc.). In describing systems and methods herein, a wireless communication device may alternatively be referred to as a mobile station, a user equipment (UE), an access terminal, a subscriber station, a mobile terminal, a remote station, a user terminal, a terminal, a subscriber unit, a mobile device, etc. Examples of wireless communication devices include cellular phones, smart phones, personal digital assistants (PDAs), laptop computers, netbooks, e-readers, wireless modems, etc. In 3GPP specifications, a wireless communication device is typically referred to as a UE. However, as the scope of the present disclosure should not be limited to the 3GPP standards, the terms “UE” and “wireless communication device” may be used interchangeably herein to mean the more general term “wireless communication device.” A UE may also be more generally referred to as a terminal device.

In 3GPP specifications, a base station is typically referred to as a Node B (3G), an evolved Node B (eNB) or a home enhanced or evolved Node B (HeNB) (4G), or some other similar terminology. As the scope of the disclosure should not be limited to 3GPP standards, the terms “base station,” “Node B,” “eNB,” and “HeNB” may be used interchangeably herein to mean the more general term “base station.” Furthermore, the term “base station” may be used to denote an access point. An access point may be an electronic device that provides access to a network (e.g., Local Area Network (LAN), the Internet, etc.) for wireless communication devices. The term “communication device” may be used to denote both a wireless communication device and/or a base station. An eNB may also be more generally referred to as a base station device.

It should be noted that as used herein, a “cell” may be any communication channel that is specified by standardization or regulatory bodies to be used for International Mobile Telecommunications-Advanced (IMT-Advanced) and all of it or a subset of it may be adopted by 3GPP as licensed bands (e.g., frequency bands) to be used for communication between an eNB and a UE. It should also be noted that in E-UTRA and E-UTRAN overall description, as used herein, a “cell” may be defined as “combination of downlink and optionally uplink resources.” The linking between the carrier frequency of the downlink resources and the carrier frequency of the uplink resources may be indicated in the system information transmitted on the downlink resources.

“Configured cells” are those cells of which the UE is aware and is allowed by an eNB to transmit or receive information. “Configured cell(s)” may be serving cell(s). The UE may receive system information and perform the required measurements on all configured cells. “Configured cell(s)” for a radio connection may consist of a primary cell and/or no, one, or more secondary cell(s). “Activated cells” are those configured cells on which the UE is transmitting and receiving. That is, activated cells are those cells for which the UE monitors the physical downlink control channel (PDCCH) and in the case of a downlink transmission, those cells for which the UE decodes a physical downlink shared channel (PDSCH). “Deactivated cells” are those configured cells that the UE is not monitoring the transmission PDCCH. It should be noted that a “cell” may be described in terms of differing dimensions. For example, a “cell” may have temporal, spatial (e.g., geographical) and frequency characteristics.

Fifth generation (5G) cellular communications (also referred to as “New Radio”, “New Radio Access Technology” or “NR” by 3GPP) envisions the use of time/frequency/space resources to allow for enhanced mobile broadband (eMBB) communication and ultra-reliable low latency communication (URLLC) services, as well as massive machine type communication (mMTC) like services. In order for the services to use the time/frequency/space medium efficiently it would be useful to be able to flexibly schedule services on the medium so that the medium may be used as effectively as possible, given the conflicting needs of URLLC, eMBB, and mMTC. A new radio base station may be referred to as a gNB. A gNB may also be more generally referred to as a base station device.

In 5G NR, at least two different types of uplink control channel (PUCCH) formats may be specified: at least one short PUCCH format and one long PUCCH format. The PUCCH channel is designed to carry uplink control information (UCI). In NR, the long PUCCH format may span over multiple slots, and the PUCCH format of a UE may be configured by a base station.

Various examples of the systems and methods disclosed herein are now described with reference to the figures, where like reference numbers may indicate functionally similar elements. The systems and methods as generally described and illustrated in the figures herein could be arranged and designed in a wide variety of different implementations. Thus, the following more detailed description of several implementations, as represented in the figures, is not intended to limit scope, as claimed, but is merely representative of the systems and methods.

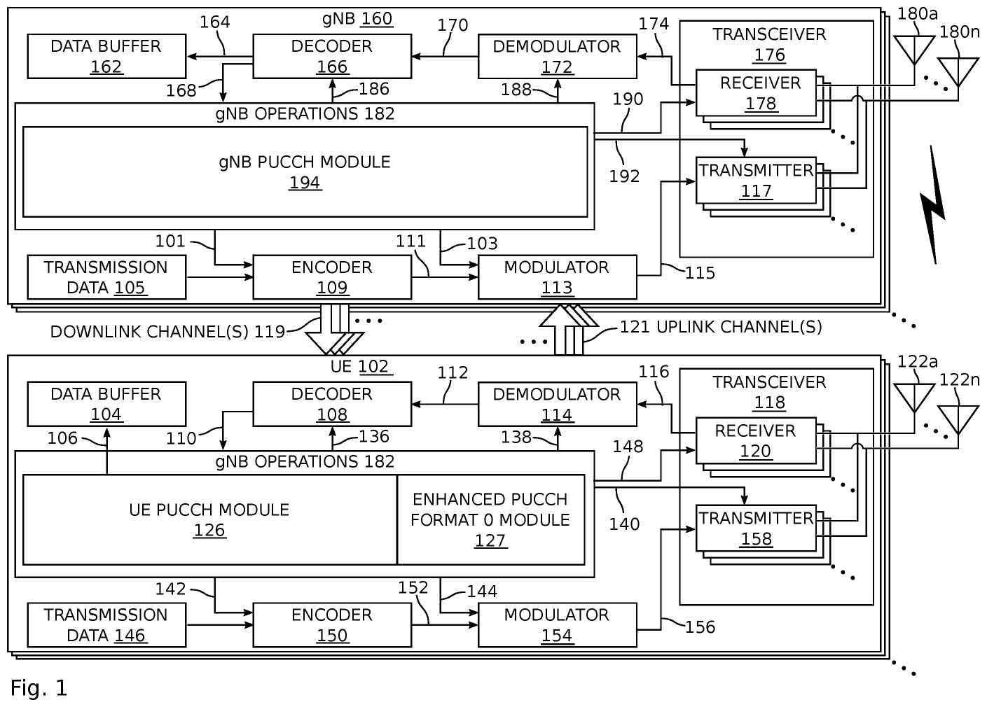

FIG. 1 is a block diagram illustrating one implementation of one or more gNBs 160 and one or more UEs 102 in which systems and methods for the improvement of URLLC PUCCH format 0 communications for 5th generation (5G) new radio (NR) may be implemented. The one or more UEs 102 communicate with one or more gNBs 160 using one or more antennas 122a-n. Alternatively but not shown, the base stations may be eNBs. For example, a UE 102 transmits electromagnetic signals to the gNB 160 and receives electromagnetic signals from the gNB 160 using the one or more antennas 122a-n. The gNB 160 communicates with the UE 102 using one or more antennas 180a-n.

The UE 102 and the gNB 160 may use one or more channels 119, 121 to communicate with each other. For example, a UE 102 may transmit information or data to the gNB 160 using one or more uplink channels 121. Examples of uplink channels 121 include a PUCCH and a PUSCH, etc. The one or more gNBs 160 may also transmit information or data to the one or more UEs 102 using one or more downlink channels 119, for instance. Examples of downlink channels 119 include a PDCCH, a PDSCH, etc. Other kinds of channels may be used.

Each of the one or more UEs 102 may include one or more transceivers 118, one or more demodulators 114, one or more decoders 108, one or more encoders 150, one or more modulators 154, a data buffer 104, and a UE operations module 124. For example, one or more reception and/or transmission paths may be implemented in the UE 102. For convenience, only a single transceiver 118, decoder 108, demodulator 114, encoder 150, and modulator 154 are illustrated in the UE 102, though multiple parallel elements (e.g., transceivers 118, decoders 108, demodulators 114, encoders 150, and modulators 154) may be implemented.

The transceiver 118 may include one or more receivers 120 and one or more transmitters 158. The one or more receivers 120 may receive signals from the gNB 160 using one or more antennas 122a-n. For example, the receiver 120 may receive and downconvert signals to produce one or more received signals 116. The one or more received signals 116 may be provided to a demodulator 114. The one or more transmitters 158 may transmit signals to the gNB 160 using one or more antennas 122a-n. For example, the one or more transmitters 158 may upconvert and transmit one or more modulated signals 156.

The demodulator 114 may demodulate the one or more received signals 116 to produce one or more demodulated signals 112. The one or more demodulated signals 112 may be provided to the decoder 108. The UE 102 may use the decoder 108 to decode signals. The decoder 108 may produce decoded signals 110, which may include a UE-decoded signal 106 (also referred to as a first UE-decoded signal 106). For example, the first UE-decoded signal 106 may comprise received payload data, which may be stored in a data buffer 104. Another signal included in the decoded signals 110 (also referred to as a second UE-decoded signal 110) may comprise overhead data and/or control data. For example, the second UE-decoded signal 110 may provide data that may be used by the UE operations module 124 to perform one or more operations.

In general, the UE operations module 124 may enable the UE 102 to communicate with the one or more gNBs 160. The UE operations module 124 may include one or more of a UE PUCCH module 126. The UE PUCCH module 126 may include an enhanced PUCCH format 0 module 127 to HARQ-ACK modifications and modified messages for 5th generation (5G) new radio (NR) as described herein.

The UE operations module 124 may provide information 148 to the one or more receivers 120. For example, the UE operations module 124 may inform the receiver(s) 120 when to receive retransmissions.

The UE operations module 124 may provide information 138 to the demodulator 114. For example, the UE operations module 124 may inform the demodulator 114 of a modulation pattern anticipated for transmissions from the gNB 160.

The UE operations module 124 may provide information 136 to the decoder 108. For example, the UE operations module 124 may inform the decoder 108 of an anticipated encoding for transmissions from the gNB 160.

The UE operations module 124 may provide information 142 to the encoder 150. The information 142 may include data to be encoded and/or instructions for encoding. For example, the UE operations module 124 may instruct the encoder 150 to encode transmission data 146 and/or other information 142. The other information 142 may include PDSCH hybrid automatic repeat request acknowledgment (HARQ-ACK) information.

The encoder 150 may encode transmission data 146 and/or other information 142 provided by the UE operations module 124. For example, encoding the data 146 and/or other information 142 may involve error detection and/or correction coding, mapping data to space, time, and/or frequency resources for transmission, multiplexing, etc. The encoder 150 may provide encoded data 152 to the modulator 154.

The UE operations module 124 may provide information 144 to the modulator 154. For example, the UE operations module 124 may inform the modulator 154 of a modulation type (e.g., constellation mapping) to be used for transmissions to the gNB 160. The modulator 154 may modulate the encoded data 152 to provide one or more modulated signals 156 to the one or more transmitters 158.

The UE operations module 124 may provide information 140 to the one or more transmitters 158. This information 140 may include instructions for the one or more transmitters 158. For example, the UE operations module 124 may instruct the one or more transmitters 158 when to transmit a signal to the gNB 160. For instance, the one or more transmitters 158 may transmit during a UL subframe. The one or more transmitters 158 may upconvert and transmit the modulated signal(s) 156 to one or more gNBs 160.

Each of the one or more gNBs 160 may include one or more transceivers 176, one or more demodulators 172, one or more decoders 166, one or more encoders 109, one or more modulators 113, a data buffer 162, and a gNB operations module 182. For example, one or more reception and/or transmission paths may be implemented in a gNB 160. For convenience, only a single transceiver 176, decoder 166, demodulator 172, encoder 109, and modulator 113 are illustrated in the gNB 160, though multiple parallel elements (e.g., transceivers 176, decoders 166, demodulators 172, encoders 109, and modulators 113) may be implemented.

The transceiver 176 may include one or more receivers 178 and one or more transmitters 117. The one or more receivers 178 may receive signals from the UE 102 using one or more antennas 180a-n. For example, the receiver 178 may receive and downconvert signals to produce one or more received signals 174. The one or more received signals 174 may be provided to a demodulator 172. The one or more transmitters 117 may transmit signals to the UE 102 using one or more antennas 180a-n. For example, the one or more transmitters 117 may upconvert and transmit one or more modulated signals 115. The one or more receivers 178 may further receive information 190 from gNB operations module 182.

The demodulator 172 may demodulate the one or more received signals 174 to produce one or more demodulated signals 170. The one or more demodulated signals 170 may be provided to the decoder 166. The gNB 160 may use the decoder 166 to decode signals. The decoder 166 may produce one or more decoded signals 164, 168. For example, a first eNB-decoded signal 164 may comprise received payload data, which may be stored in a data buffer 162. A second eNB-decoded signal 168 may comprise overhead data and/or control data. For example, the second eNB-decoded signal 168 may provide data (e.g., PDSCH HARQ-ACK information) that may be used by the gNB operations module 182 to perform one or more operations.

In general, the gNB operations module 182 may enable the gNB 160 to communicate with the one or more UEs 102. The gNB operations module 182 may include one or more of a gNB PUCCH module 194.

The gNB operations module 182 may provide information 188 to the demodulator 172. For example, the gNB operations module 182 may inform the demodulator 172 of a modulation pattern anticipated for transmissions from the UE(s) 102.

The gNB operations module 182 may provide information 186 to the decoder 166. For example, the gNB operations module 182 may inform the decoder 166 of an anticipated encoding for transmissions from the UE(s) 102. The gNB operations module 182 may provide information 101 to the encoder 109. The information 101 may include data to be encoded and/or instructions for encoding. For example, the gNB operations module 182 may instruct the encoder 109 to encode information 101, including transmission data 105.

The encoder 109 may encode transmission data 105 and/or other information included in the information 101 provided by the gNB operations module 182. For example, encoding the data 105 and/or other information included in the information 101 may involve error detection and/or correction coding, mapping data to space, time and/or frequency resources for transmission, multiplexing, etc. The encoder 109 may provide encoded data 111 to the modulator 113. The transmission data 105 may include network data to be relayed to the UE 102.

The gNB operations module 182 may provide information 103 to the modulator 113. This information 103 may include instructions for the modulator 113. For example, the gNB operations module 182 may inform the modulator 113 of a modulation type (e.g., constellation mapping) to be used for transmissions to the UE(s) 102. The modulator 113 may modulate the encoded data 111 to provide one or more modulated signals 115 to the one or more transmitters 117.

The gNB operations module 182 may provide information 192 to the one or more transmitters 117. This information 192 may include instructions for the one or more transmitters 117. For example, the gNB operations module 182 may instruct the one or more transmitters 117 when to (or when not to) transmit a signal to the UE(s) 102. The one or more transmitters 117 may upconvert and transmit the modulated signal(s) 115 to one or more UEs 102.

It should be noted that a DL subframe may be transmitted from the gNB 160 to one or more UEs 102 and that a UL subframe may be transmitted from one or more UEs 102 to the gNB 160. Furthermore, both the gNB 160 and the one or more UEs 102 may transmit data in a standard special subframe.

It should also be noted that one or more of the elements or parts thereof included in the eNB(s) 160 and UE(s) 102 may be implemented in hardware. For example, one or more of these elements or parts thereof may be implemented as a chip, circuitry, or hardware components, etc. It should also be noted that one or more of the functions or methods described herein may be implemented in and/or performed using hardware. For example, one or more of the methods described herein may be implemented in and/or realized using a chipset, an application-specific integrated circuit (ASIC), a large-scale integrated circuit (LSI), or integrated circuit, etc.

The physical uplink control channel for NR may support multiple formats as shown it Table 1. Simultaneous transmission of two PUCCHs with format 0 or 2, or simultaneous transmission of one PUCCH with format 1 or 3 and one PUCCH with format 0 or 2 from a single UE may be supported.

TABLE 1

| PUCCH format | Length in OFDM symbols | Number of bits |
|---|---|---|
| 0 | 1-2 | ≤2 |
| 1 | 4-14 | ≤2 |
| 2 | 1-2 | >2 |
| 3 | 4-14 | >2 |
| 4 | 4-14 | >2 |

PUCCH format 0 may be a short PUCCH with up to 2 bits of UCI. PUCCH format 0 may use sequences to indicate the UCI values. PUCCH format 0 may occupy a single resource block (RB) by default and 1 or 2 symbols in a slot.

PUCCH format 1 may be a long PUCCH with up to 2 bits of UCI. PUCCH format 1 may use sequences to indicate the UCI values. PUCCH format 1 may occupy a single RB by default and 4-14 symbols in a slot. Time domain orthogonal cover code (OCC) may be applied for PUCCH multiplexing with other UEs.

PUCCH format 2 may be a short PUCCH with more than 2 bits of UCI. PUCCH format 2 may use orthogonal frequency division multiplexing (OFDM) with UCI and DMRS multiplexing in a RB. PUCCH format 2 may occupy 1 or 2 symbols in a slot with configurable RBs to allow different number of UCI payload sizes.

PUCCH format 3 may be a long PUCCH with more than 2 bits of UCI without UE multiplexing. PUCCH format 3 may use DFT-S-OFDM and time division multiplexing (TDM) between UCI and DMRS. PUCCH format 3 may occupy 4-14 symbols in a slot with configurable RBs to allow different number of UCI payload sizes.

PUCCH format 4 may be a long PUCCH with more than 2 bits of UCI with UE multiplexing. PUCCH format 4 may use DFT-S-OFDM and TDM between UCI and DMRS. PUCCH format 3 may occupy 4-14 symbols in a slot. Pre-DFT OCC may be applied for PUCCH multiplexing with other UEs.

Therefore, for PUCCH format configuration, a combination of semi-static configuration and (at least for some types of UCI information) dynamic signaling is used to determine the PUCCH formats and resources both for the long and short PUCCH formats.

TABLE 2
Parameters configured in PUCCH resource sets and their value ranges

| | | PUCCH | PUCCH | PUCCH | PUCCH | PUCCH |
|---|---|---|---|---|---|---|
| — | | Format 0 | Format 1 | Format 2 | Format 3 | Format 4 |
| Starting | Configurability | Configured | Configured | Configured | Configured | Configured |
| Slot | Value Range | 0-x | 0-x | 0-x | 0-x | 0-x |
| Starting | Configurability | Configured | Configured | Configured | Configured | Configured |
| Symbol | Value Range | 0-13 (such | 0-10 | 0-13 (such | 0-10 | 0-10 |
| | | a | | a | | |
| | | configuration | | configuration | | |
| | | may be | | may be | | |
| | | conditioned | | conditioned | | |
| | | on non-slot | | on non-slot | | |
| | | based | | based | | |
| | | operation) | | operation) | | |
| Number of | Configurability | Configured | Configured | Configured | Configured | Configured |
| symbols in | Value Range | 1, 2 | 4-14 | 1, 2 | 4-14 | 4-14 |
| a slot | | | | | | |
| Index for | Configurability | Configured | Configured | Configured | Configured | Configured |
| identifying | | (implicit | (implicit | | | |
| starting | | derivation | derivation | | | |
| physical | | may also be | may also be | | | |
| resource | | used) | used) | | | |
| block | Value Range | 0-274 | 0-274 | 0-274 | 0-274 | 0-274 |
| (PRB) | | | | | | |
| Number of | Configurability | N.A. | N.A. | Configured | Configured | N.A. |
| PRBs | Value Range | N.A. | N.A. | 1-16 | 1-6, 8-10, | N.A. |
| | | (Default is 1) | (Default is | | 10, 12, 15, | (Default is |
| | | | 1) | | 16 | 1) |
| Enabling a | Configurability | Configured | Configured | Configured | Configured | Configured |
| frequency | Value Range | On/Off | On/Off | On/Off | On/Off | On/Off |
| hopping | | (only for 2 | | (only for 2 | | |
| | | symbols) | | symbols) | | |
| Frequency | Configurability | Configured | Configured | Configured | Configured | Configured |
| resource of | h1-h2 if | h1-h2 if | h1-h2 if | h1-h2 if | h1-h2 if | h1-h2 if |
| second hop | configured | configured | configured | configured | configured | configured |
| if frequency | | | | | | |
| hopping is | | | | | | |
| enabled | | | | | | |
| Index of | Configurability | Yes | Yes | N.A. | Yes/No | Yes/No |
| initial | | (implicit | (implicit | | (for DMRS) | (for DMRS) |
| cyclic shift | | derivation | derivation | | | |
| | | may also be | may also be | | | |
| | | used) | used) | | | |
| | Value Range | 0-11 | 0-11 | N.A. | 0-11 | 0-11 |
| Index of | Configurability | N.A. | Configured | N.A. | N.A. | N.A. |
| time- | | | (implicit | | | |
| domain | | | derivation | | | |
| OCC | | | may also be | | | |
| | | | used) | | | |
| | Value Range | N.A. | 0-6 | N.A. | N.A. | N.A. |
| Length of | Configurability | N.A. | N.A. | N.A. | N.A. | Configured |
| Pre-DFT | Value Range | N.A. | N.A. | N.A. | N.A. | 2, 4 |
| OCC | | | | | | |
| Index of | Configurability | N.A. | N.A. | N.A. | N.A. | Configured |
| Pre-DFT | Value Range | N.A. | N.A. | N.A. | N.A. | 0, 1, 2, 3 |
| OCC | | | | | | |

TABLE 3
Semi-statically-configured parameters and their value ranges

| | | PUCCH | PUCCH | PUCCH | PUCCH | PUCCH |
|---|---|---|---|---|---|---|
| — | | Format 0 | Format 1 | Format 2 | Format 3 | Format 4 |
| Starting | Configurability | N.A. | Configured | N.A. | Configured | Configured |
| Slot | Value Range | N.A. | 1, y1, y2, | N.A. | 1, y1, y2, | 1, y1, y2, |
| | | | y3 | | y3 | y3 |

PUCCH is used to report important uplink control information (UCI), which includes HARQ-ACK, Scheduling Request (SR), and Channel State Information (CSI) etc. NR release-15 is designed mainly for enhanced mobile broadband (eMBB), several physical uplink control channel (PUCCH) formats are specified for different number of bits, as given below.

Specification section (see Table 1, above):

6.3.2 Physical uplink control channel

6.3.2.1 General
The physical uplink control channel supports multiple formats as shown in Table 6.3.2.1-1. In case frequency hopping is configured for PUCCH format 1, 3, or 4, the number of symbols in the first hop is given by └N_{symb}^{PUCCG}/2┘ where N_{symb}^{PUCCH} is the length of the PUCCH transmission in OFDM symbols.

In 5G NR, different services can be supported with different quality of service (QoS) requirements, e.g. reliability and delay tolerance. For example, enhanced Mobile Broadband (eMBB) is targeted for high data rate, and URLLC is for ultra-reliability and low latency. The URLLC traffic may use the same numerology as eMBB service. The URLLC downlink transmission may also use a different subcarrier spacing (SCS) as eMBB DL transmission. For example, the URLLC traffic may use a higher numerology than eMBB service, i.e. the SCS of a URLLC transmission may be larger than that of an eMBB transmission. A larger SCS configuration for URLLC reduces the length of an OFDM symbol, and thus the latency of a transmission and its HARQ-ACK feedback.

The URLLC DL transmission and UL transmission may be configured with the same numerology. The URLLC DL transmission and UL transmission may be configured with the different numerologies. For HARQ-ACK feedback for of DL URLLC transmission, URLLC short PUCCH may use a different numerology from other short PUCCH, and the URLLC PUCCH should have shorter symbol lengths than other short PUCCH or PUSCH transmissions. Systems and methods related to URLLC DL data transmission and the corresponding HARQ-ACK feedback on PUCCH are presented below.

To provide ultra-reliability for URLLC traffic, a different Channel Quality Indicator (CQI) and Modulation and Coding Scheme (MCS) table maybe configured for URLLC with 10⁻⁵ error probability. At the same time, the PUCCH for HARQ-ACK feedback of URLLC data can be enhanced at least to the same reliability level as the data for URLLC.

For URLLC traffic, several aspects need to be considered for PUCCH design and PUCCH transmissions. Since URLLC traffic requires ultra-reliability and low latency, the HARQ-ACK for URLLC packet should be supported to provide the required reliability. Furthermore, the HARQ-ACK feedback should be reported immediately after a URLLC transmission. Moreover, the HARQ-ACK feedback should have the same reliability as the URLLC data transmission, i.e. the current PUCCH channel BER requirements of 1% or 0.1% cannot satisfy the URLLC requirements. The HARQ-ACK bit error rate (BER) requirement should be the same or better than the URLLC data channel, i.e. at least 10⁻⁵ or 10⁻⁶.

The URLLC traffic may share the HARQ-ACK processes with eMBB, however, the number of HARQ-ACK processes for URLLC can be limited, e.g., only 1 or HARQ-ACK processes for URLLC traffic. Thus, the PUCCH format for URLLC DL transmission should also provide ultra-reliability and low latency after a URLLC DL transmission. Only short PUCCH should be used for URLLC HARQ-ACK feedback. The position of short PUCCH can be determined dynamically based on URLLC DL data transmission, e.g. immediately after a URLLC DL transmission with a gap satisfying the processing time requirements. Due to the ultra-low latency requirements, the PUCCH format 0, i.e. the short PUCCH with up to 2 bits of UCI, is more suitable for URLLC data HARQ-ACK feedback.

The NR PUCCH format 0 occupies a single physical resource block (PRB) and uses sequences to indicate up to 2 bits of payload, as shown below

//spec section

### 6.3.2.3 PUCCH Format 0

### 6.3.2.3.1 Sequence Generation

The sequence x(n) shall be generated according to

$$x ( l \cdot {N}_{sc}^{RB} + n ) = {r}_{u , v}^{( α , δ )} ( n )$$

$$n = 0 , 1 , … , {N}_{sc}^{RB} - 1$$

$$l = \{ \begin{matrix}0 & for single \text{-} symbol PUCCH transmission \\ 0 , 1 & for double \text{-} symbol PUCCH transmission\end{matrix}$$

where r_{u,v}^{(α,δ)}(n) is given by clause 6.3.2.2 with m_{cs} depending on the information to be transmitted according to subclause 9.2 of [5, TS 38.213].

### 6.3.2.3.2 Mapping to Physical Resources

The sequence x(n) shall be multiplied with the amplitude scaling factor β_{PUCCH,0} in order to conform to the transmit power specified in [5, TS 38.213] and mapped in sequence starting with x(0) to resource elements (k,l)_{p,μ} assigned for transmission according to subclause 9.2.1 of [5, TS 38.213] in increasing order of first the index k over the assigned physical resources, and then the index l on antenna port p=2000.

### TS 38.331

-- A PUCCH Format 0 resource configuration (see 38.213, section 9.2)
-- Corresponds to L1 parameter ‘PUCCH-F0-resource-config’ (see 38.213,
section 9.2)

| | |
|---|---|
| PUCCH-format0 | SEQUENCE { |
| startingSymbolIndex | INTEGER(0..13), |
| nrofSymbols | ENUMERATED {n1, n2}, |
| startingPRB | |

INTEGER(0..maxNrofPhysicalResourceBlocks-1),

| | |
|---|---|
| frequencyHopping | BOOLEAN, |
| initialCyclicShift | INTEGER(0..11) |
| } | |

//end of spec section

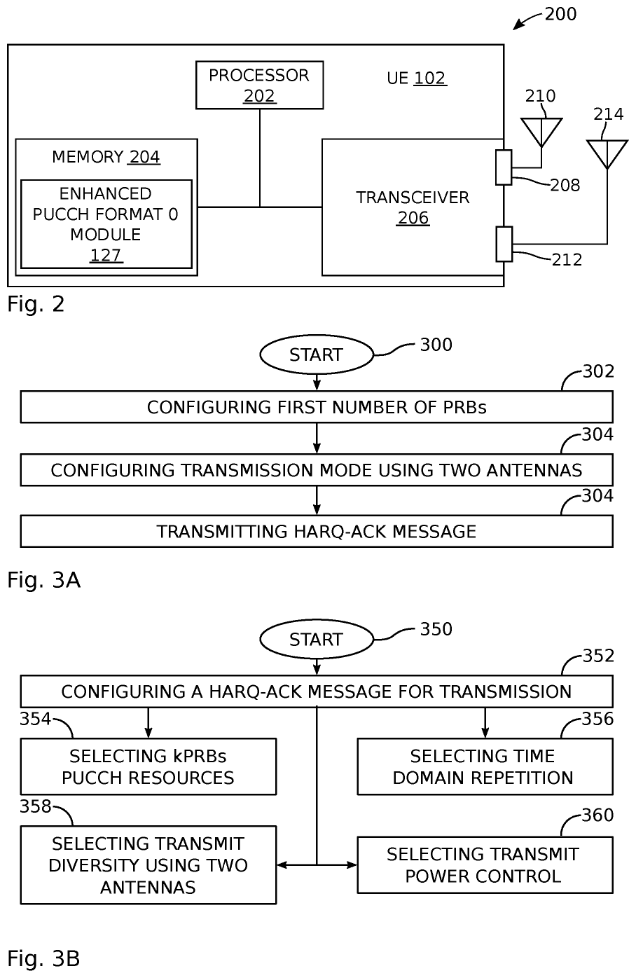

FIG. 2 is a schematic block diagram depicting a UE 102 operating in a wireless communications network 200. The UE 102 comprises a processor 202, a non-transitory memory 204, and a transceiver 206. An enhanced PUCCH format 0 module 127 resides in the memory 204, and is electrically connected to the transceiver 206. A first antenna port 208 is connected to transceiver 206 and first antenna 210. A second antenna port 212 is connected to transceiver 206 and second antenna 214. The enhanced PUCCH format 0 module 127 includes a sequence of processor instructions for configuring a first number of PRBs for a PUCCH resource. More explicitly, the enhanced PUCCH format 0 module 127 configures k PRBs for the PUCCH resource, where k is an integer greater than or equal to one. In response to receiving a Radio Resource Control (RRC) message, enhanced PUCCH format 0 module 127 configures a transmission mode using two antenna ports for the PUCCH format 0. That is, the enhanced PUCCH format 0 module 127 determines the PUCCH resource used for transmission on each antenna port based on the PUCCH resource configuration. Then, the enhanced PUCCH format 0 module transmits a HARQ-ACK message corresponding to a Physical Downlink Shared Channel (PDSCH) using the two antenna ports 208 and 212. Typically, the enhanced PUCCH format 0 module transmits the HARQ-ACK message with a length of up to 2 bits. Further, the enhanced PUCCH format 0 module may schedule the PDSCH transmission using Downlink Control Indicator (DCI) scrambled with a Radio Network Temporary Identifier (RNTI) different from (C-RNTI).

In one aspect, the enhanced PUCCH format 0 module 127 configures one PRB for the PUCCH resource. The enhanced PUCCH format 0 module 127 transmits the HARQ-ACK message on first antenna port 208 in one PRB of the configured PUCCH resource, and transmits the HARQ-ACK message on second antenna port 212 in a next adjacent one PRB of the configured PUCCH resource. As an alternative, the enhanced PUCCH format 0 module 127 configures more than 1 (k>1) PRBs for the PUCCH resource. Then, the enhanced PUCCH format 0 module 127 transmits the HARQ-ACK message on first antenna port 208 in the k PRBs of the configured PUCCH resource, and transmits the HARQ-ACK message on second antenna port 212 in next adjacent k PRBs of the configured k PRBs PUCCH resource.

In a variation of the above-described UE, the enhanced PUCCH format 0 module 127 configures for transmission a HARQ-ACK message corresponding to the PDSCH using additional reliability enhancement mechanisms. Typically, the enhanced PUCCH format 0 module 127 configures the reliability enhancement mechanism in response to the transceiver receiving a RRC message from a base station, as mentioned above. In addition to the k number of PRBs method described above, the enhanced PUCCH format 0 module 127 may use time domain repetition of a configured PUCCH, transmit diversity using the two antenna ports 208 and 212, or transmit power control. In one aspect, the enhanced PUCCH format 0 module 127 uses the k number of PRBs PUCCH resource mechanism in combination with the transmit diversity mechanism using the two antenna ports 208 and 212.

In the case of time repetition, the enhanced PUCCH format 0 module 127 uses one of the following frequency hopping schemes: frequency hopping at each PUCCH boundary, a single frequency hop for a plurality of PUCCH repetitions, or intra-PUCCH frequency hopping. These frequency hopping schemes are described in more detail below.

In the case of transmit power control, the enhanced PUCCH format 0 module 127 configures the HARQ-ACK message for transmission at an increased power level, as compared to a conventional PUCCH format 0 message, in response to using an enhanced reliability amplitude scaling factor. The enhanced PUCCH transmit power is given by an amplitude scaling factor within more than one configured amplitude scaling factors for a given PUCCH format, with the highest amplitude factor being optionally configurable for enhanced PUCCH format 0. Alternatively stated, the enhanced PUCCH transmit power is given by a separately configured multiplier factor over a configured amplitude scaling factor for a legacy (conventional) PUCCH format.

FIG. 3A is a flowchart illustrating, for a wireless communications network UE, a method for enhanced reliability. The method begins at Step 300. In Step 302 an enhanced PUCCH format 0 module, residing in a non-transitory memory and comprising a sequence of processor instructions, configures a first number of PRBs for a PUCCH resource. In response to receiving a RRC message, in Step 304 the enhanced PUCCH format 0 module configures a transmission mode using two antenna ports for the PUCCH format 0. In Step 306 the enhanced PUCCH format 0 module transmits a HARQ-ACK message corresponding to a PDSCH using the two antenna ports.

In one aspect, configuring the first number of PRBs in Step 302 includes configuring k PRBs for the PUCCH resource, where k is an integer greater than or equal to one. In another aspect, configuring the transmission mode in Step 304 includes determining the PUCCH resource used for transmission on each antenna port based on the PUCCH resource configuration.

FIG. 3B is a flowchart illustrating a different aspect of the wireless communications network UE method for enhanced reliability. The method begins at Step 350. In Step 352 an enhanced PUCCH format 0 module residing in a non-transitory memory and comprising a sequence of processor instructions, configures for transmission a HARQ-ACK message corresponding to a PDSCH using a reliability enhancement mechanism. In Step 354 the enhanced PUCCH format 0 module selects the mechanism using k PRBs PUCCH resources, where k is a configurable integer greater than or equal to one. Alternatively, in Step 356 the enhanced PUCCH format 0 module selects time domain repetition of a configured PUCCH. As another alternative, in Step 358 the enhanced PUCCH format 0 module selects transmit diversity using two antenna ports, and in yet another alternative, in Step 360, the enhanced PUCCH format 0 module selects transmit power control.

Returning to FIG. 2, and as described above, the UE 102 comprises an (at least one) antenna port 208 and (at least one) antenna 210. An enhanced PUCCH format 0 module 127 resides in the memory 204 and is electrically connected to the transceiver 206. The enhanced PUCCH format 0 module 127 includes a sequence of processor instructions for configuring a first number of PRBs for a PUCCH resource. The enhanced PUCCH format 0 module 127 determines a second number of repetitions for the PUCCH resource, and also determines if frequency hopping is enabled for PUCCH messages. If enabled, the enhanced PUCCH format 0 module 127 may use one of the following frequency hopping schemes: frequency hopping at each PUCCH boundary, a single frequency hop for a plurality of PUCCH repetitions, or intra-PUCCH frequency hopping.

The enhanced PUCCH format 0 module 127 transmits a HARQ-ACK message corresponding to a PDSCH on the PUCCH format 0. Alternatively stated, the enhanced PUCCH format 0 module 127 configures the HARQ-ACK for transmission by the transceiver 206. The HARQ-ACK message may be up to 2 bits in length, and the enhanced PUCCH format 0 module may schedule the PDSCH transmission using Downlink Control Indicator (DCI) scrambled with a Radio Network Temporary Identifier (RNTI) different from C-RNTI.

In one aspect, the enhanced PUCCH format 0 module 127 configures k PRBs for the PUCCH resource, where k is an integer greater than or equal to one. The enhanced PUCCH format 0 module 127 configures l repetitions for the PUCCH resource, where l is an integer greater than or equal to one. Then, the enhanced PUCCH format 0 module 127 transmits the HARQ-ACK message on the PUCCH resource of adjacent k PRBs with l repetitions of continuous symbols in the time domain. For example, if the PUCCH is a 2-symbol PUCCH resource and frequency hopping is enabled, the enhanced PUCCH format 0 module 127 may transmit the HARQ-ACK message on a 2-symbol PUCCH resource with intra-PUCCH frequency hopping.

Alternatively, if the PUCCH is configured with l repetitions and inter-PUCCH frequency hopping is enabled, the enhanced PUCCH format 0 module 127 transmits the HARQ-ACK message on the PUCCH resource with inter-PUCCH frequency hopping. For example, the frequency hopping may performed at each PUCCH resource boundary for the inter-PUCCH frequency hopping. As another example, single frequency hopping is performed in the middle of l PUCCH repetitions for the inter-PUCCH frequency hopping, where the middle is defined by the PUCCH boundary after the ith PUCCH repetition, where i is determined by either floor (l/2) or ceiling(l/2). As a third example, for a 2-symbol PUCCH, the intra-PUCCH frequency hopping may be disabled when inter-PUCCH frequency hopping is enabled.

Further, if a 2-symbol PUCCH is configured with l repetitions, inter-PUCCH frequency hopping may disabled when intra-PUCCH frequency hopping is enabled, and the enhanced PUCCH format 0 module 127 transmits the HARQ-ACK message on the PUCCH resource with frequency hopping within each 2-symbol PUCCH resource.

In another aspect, the enhanced PUCCH format 0 modules 127 configures the first number of PRBs for the PUCCH resource in response to the transceiver receiving a first RRC message from a base station. The enhanced PUCCH format 0 module 127 also configures the number of repetitions of PUCCH resource in the time domain, in response to the transceiver receiving a second RRC message from a base station. As a result, the enhanced PUCCH format 0 module determines frequency hopping enablement in response to the transponder receiving a third RRC message from the base station.

In a different variation of the UE, the enhanced PUCCH format 0 module 127 configures a first reference subcarrier spacing and a second reference subcarrier spacing. Based on the first subcarrier spacing and second subcarrier spacing, the enhanced PUCCH format 0 module 127 determines a number of repetitions, and then transmits a HARQ-ACK message, of up to 2 bits in length, with the determined number of repetitions, corresponding to a PDSCH. As above, the enhanced PUCCH format 0 module 127 may use frequency hopping at each PUCCH boundary, a single frequency hop for a plurality of PUCCH repetitions, and intra-PUCCH frequency hopping.

In one aspect, the enhanced PUCCH format 0 module 127 configures the HARQ-ACK message with the determined number of repetitions using a 1-symbol PUCCH format 0 message repeated k number of times, where k is an integer greater than or equal to 1. Alternatively, the enhanced PUCCH format 0 module 127 may use a 2-symbol PUCCH format 0 message repeated k/2 number of times. As in the first variation, the enhanced PUCCH format 0 module 127 may schedule the PDSCH transmission using DCI scrambled with a RNTI different from C-RNTI.

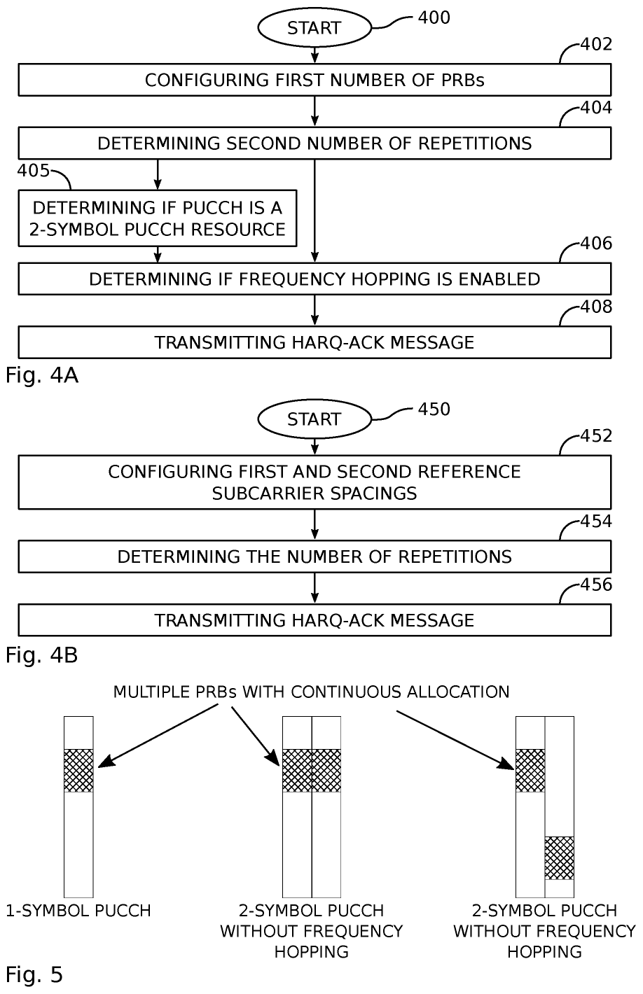

FIG. 4A is a flowchart illustrating a method for enhanced reliability in a UE comprising a non-transitory memory, with an enhanced PUCCH module residing in the memory and including a sequence of processor executable instructions. The method begins at Step 400. In Step 402 the enhanced PUCCH format 0 module configures a first number of PRBs for a PUCCH resource. In Step 404 the enhanced PUCCH format 0 module determines a second number of repetitions for the PUCCH resource. In Step 406 the enhanced PUCCH format 0 module determines frequency hopping enablement for PUCCH messages (i.e., determines if frequency hopping is available). In Step 408 the enhanced PUCCH format 0 module transmits a HARQ-ACK message corresponding to a PDSCH on the PUCCH format 0. That is, the enhanced PUCCH format 0 module configures the HARQ-ACK message for transmission by a transceiver.

In one aspect, configuring the first number of PRBs for the PUCCH resource in Step 402 includes configuring k PRBs for the PUCCH resource, where k is an integer greater than or equal to one. Determining the second number of repetitions for the PUCCH resource in Step 404 includes configuring/repetitions for the PUCCH resource, where/is an integer greater than or equal to one. Then, transmitting the HARQ-ACK message in Step 408 includes configuring the HARQ-ACK message corresponding to a PDSCH transmission on the PUCCH resource of adjacent k PRBs with/repetitions of continuous symbols in the time domain.

Optionally, in Step 405 the enhanced PUCCH format 0 module may determine that the PUCCH is a 2-symbol PUCCH resource. Then, determining frequency hopping enablement in Step 406 includes determining that frequency hopping is enabled, and transmitting the HARQ-ACK message in Step 408 includes configuring the HARQ-ACK message on a 2-symbol PUCCH resource with intra-PUCCH frequency hopping.

In another aspect, determining the second number of repetitions for the PUCCH resource in Step 404 includes configuring the PUCCH with/repetitions, and determining frequency hopping enablement in Step 406 includes determining inter-PUCCH frequency hopping is enabled. Then, transmitting the HARQ-ACK message in Step 408 includes configuring the HARQ-ACK message on the PUCCH resource with inter-PUCCH frequency hopping.

FIG. 4B is a flowchart illustrating an alternate method for improving reliability. As above, the method is applicable to a UE comprising a non-transitory memory and an enhanced PUCCH module residing in the memory and including a sequence of processor executable instructions. The method begins at Step 450. In Step 452 the enhanced PUCCH format 0 module configures a first reference subcarrier spacing and a second reference subcarrier spacing. In Step 454 the enhanced PUCCH format 0 module, based on the first subcarrier spacing and second subcarrier spacing, determines a number of repetitions. In Step 456 the enhanced PUCCH format 0 module transmits (or configures for transmission) a HARQ-ACK message with the determined number of repetitions, corresponding to a PDSCH.

Reliability Enhancement for PUCCH Format 0:

For URLLC HARQ-ACK feedback, the reliability of PUCCH format 0 should be enhanced to at least an error rate of 10⁻⁵ or 10⁻⁶, e.g. the ACK to NACK error probability is 10⁻⁵, and NACK to ACK error probability is 10⁻⁶. Thus, a new PUCCH format is specified herein for a short PUCCH with ultra-high reliability by extending the PUCCH format 0. Although referred to herein as the enhanced PUCCH format module, the new PUCCH format may alternatively be named as PUCCH format 5, PUCCH format 0_1, advanced PUCCH format 0 (PUCCH format 0a), PUCCH Format 0e, ultra-reliable PUCCH format 0 (PUCCH format 0_r, or format 0_u), etc.

Several techniques have been summarized above that can be used to increase the reliability, at least for PUCCH format 0. Allocating more resources is a straightforward way to increase the PUCCH reliability.

More than One PRBs May be Configured for a Sequence Based PUCCH Format 0

Instead of being limited to 1 PRB, multiple PRBs can be configured for a PUCCH with ultra-reliability. The number of PRB can be configured by higher layer signaling, e.g. RRC configuration, or RRC message. The number of PRBs may be configured within a set of potential values, e.g. {1,2,4,8}, and the indexes of the values can be indicated or configured by the gNB.

FIG. 5 is a diagram depicting an enhanced PUCCH format 0 with multiple PRB allocations. As shown, when multiple PRBs are configured, an enhanced PUCCH format 0 channel uses continuous PRBs from the starting PRB. If 2-symbol PUCCH is configured, the frequency hopping can be further configured. If frequency hopping is configured, continuous PRB allocation is applied on the symbol of each hop.

In conventional PUCCH format 0, only 1 PRB is occupied. Thus, the sequence transmitted on the PUCCH resource is a length-12 sequence. With more than 1 PRB configured for an enhance PUCCH format 0, the length of the sequence transmitted on the PUCCH resource is determined by the number of PRBs and the number of subcarriers per PRB. The sequence is a low Peak-to-Average Power Ratio (PAPR) sequence defined in Section 5.2.2. of TS 38.211.

Signaling
The Enhanced PUCCH format 0 resource may be configured as one of the PUCCH resources within a PUCCH resource set. A UE may select one PUCCH resource according to the UCI payload size.
The PUCCH resource configuration may a PUCCH format, time-domain resource (starting symbol within a slot, the number of PRBs, the duration of PUCCH (i.e. the number of OFDM symbols), cyclic shift, the number of repetitions of PUCCH (the number of repetitions of PUCCH symbol(s), and/or, hopping pattern, etc.). And the PUCCH resource configuration may be configured by RRC. The UE may use the PUCCH resource indicated by DCI.
As another signaling scheme, the potential numbers of PRBs (e.g. {2, 4, 8, 16} PRBs) are configured and one of the configured numbers of PRBs is indicated by DCI. The Acknowledgement Resource Indicator (ARI) field in DCI may be used for the selection, determination, or indication of the number of PRBs.
As another signaling scheme, the number of PRBs is configured by RRC. And the number of PRBs is associated with one or more PUCCH resources within a PUCCH resource set.

Time Domain Repetition of PUCCH Format 0

PUCCH format 0 may be configured with 1 or 2 symbols. Besides the number of PRBs, time domain repetition is another way to provide redundancy and reliability for PUCCH. However, too many repetitions on time domain are not desirable due to low latency requirements. Therefore, the numbers of time domain repetitions may be limited to 2, 4, and 8.

When PUCCH repetition is configured for an enhanced PUCCH format 0, the configured PUCCH format 0 may be repeated continuously in time domain from the starting symbol.

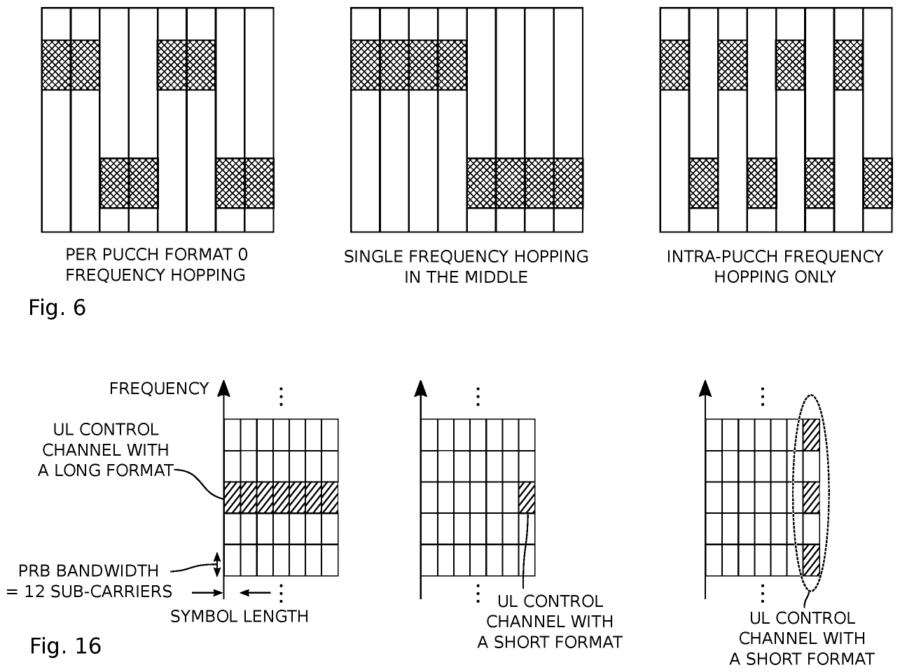

FIG. 6 includes diagrams depicting time domain repetition with the use of frequency hopping. Several approaches can be considered. The figure shows some examples of 2-symbol with 4 repetitions in time domain.

Approach 1: Per PUCCH Format 0 Configuration

The frequency hopping can be configured per PUCCH repetition. Thus, the frequency hopping is applied at each PUCCH boundary. The frequency hopping may be configured by an inter-PUCCH hopping parameter by higher layer signaling. For a two-symbol PUCCH, if inter-PUCCH frequency hopping is enabled, intra-PUCCH frequency hopping in each PUCCH is disabled.

Signaling
The frequency hopping may be configured by RRC. The frequency hopping may be associated with one or more PUCCH resource(s).
The frequency hopping may include hopping enabling/disabling and/or hopping pattern.
Hopping pattern may be included the number of OFDM symbols per hop and/or the starting PRB per hop.
The starting PRB may be implicitly determined by the number of OFDM symbols per hop. For example, the starting PRB of the 1^{st} hop may be determined by CCE index. The second hop is determined by an equation based on the number of allocated PRBs for enhanced PUCCH format 0.

Approach 2: A Single Hop in the Middle of all PUCCH Repetitions

In this case, only one hop is applied to all PUCCH repetitions in the middle. For example, if the repetition factor is 4, a single hop is applied after the first two PUCCH transmissions. In general, if l repetitions are configured, a single hop is applied after the ith PUCCH transmissions, where i is determined by floor(l/2) or ceil(l/2). The frequency hopping may be configured by an inter-PUCCH hopping parameter by higher layer signaling. For a two symbol PUCCH, if inter-PUCCH frequency hopping is enabled, intra-PUCCH frequency hopping is disabled.

Signaling
The number of repetitions may be configured RRC. The number of repetitions per hop may be configured by RRC. The number of repetitions and/or the number of hops may be associated with the PUCCH resource.
The number of hops may be determined by the number of OFDM symbols for the PUCCH resource.

Approach 3: Intra-PUCCH Hopping Only for 2-Symbol PUCCH

If inter-PUCCH hopping parameter is not configured by higher layer signaling, for a 2 symbol PUCCH format 0, intra-PUCCH frequency hopping may be configured. In this case, frequency hopping is performed at each symbol boundary.

Especially if the URLLC PUCCH uses a higher SCS setting than eMBB traffic, the symbol duration of URLLC PUCCH becomes shorter, and time domain repetition can be configured. In this case, the enhanced PUCCH format 0 for URLLC may be repeated to fit the symbol duration of the reference numerology defined by eMBB services. This avoids partial symbol overlapping between transmissions with different numerologies.

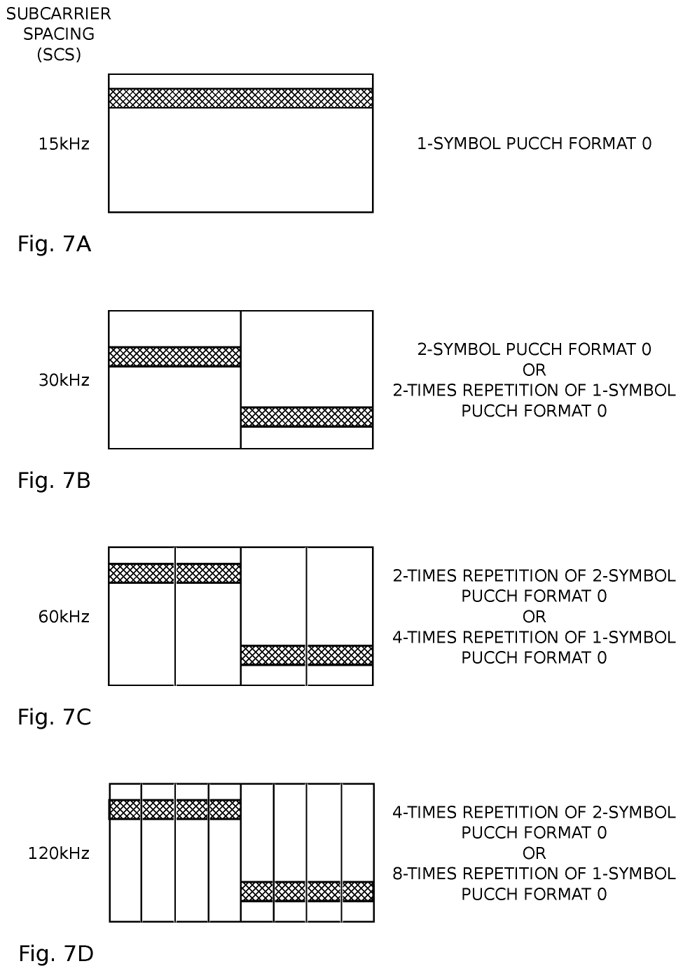

FIGS. 7A through 7D are diagrams depicting URLLC PUCCH Subcarrier Spacing (SCS). For example, if a 15 Khz subcarrier spacing (SCS) (e.g., first SCS) is used as reference numerology, then the URLLC may use a 60 HKz subcarrier spacing (e.g., second SCS). Four 60 KHz SCS symbols can be transmitted in a symbol with 15 KHz SCS. If a one symbol PUCCH is configured for enhanced PUCCH format 0 with 60 KHz SCS, it can be repeated 4 times to fit into a symbol with 15 KHz. Similarly, if a two symbol PUCCH is configured for enhanced PUCCH format 0 with 60 KHz SCS, it can be repeated 2 times to fit into a symbol with 15 KHz., and so on, as shown.

Here, the first SCS may be configured by using the RRC message. Also, a default value of the first SCS may be defined based on a frequency band(s). For example, the default value of the first SCS may be defined based on the frequency band(s), in advance, by the specifications. For example, if the first SCS is configured by using the RRC message, the UE may use the first SCS configured by using the RRC message, as the reference numerology. Also, if the first SCS is not configured by using the RRC message, the UE may use the default value of the first SCS as the reference numerology. For example, the first SCS may be configured for each of bandwidth parts (e.g., UL bandwidth parts). Also, the first SCS may be configured for each of serving cells. Also, the first SCS may be configured (e.g., separately configured) for each of PUCCH formats (e.g., PUCCH format 0, PUCCH format 1, and/or PUCCH format 3, etc.). Also, the first SCS may be configured (e.g., commonly configured) for more than one PUCCH formats (e.g., PUCCH format 0, PUCCH format 1, and/or PUCCH format 3, etc.).

The second SCS may be configured by using the RRC message. Further, a default value of the second SCS may be defined based on a frequency band(s). For example, the default value of the second SCS may be defined based on the frequency band(s), in advance, by the specifications. For example, if the second SCS is configured by using the RRC message, the UE may use the second SCS configured by using the RRC message. Also, if the second SCS is not configured by using the RRC message, the UE may use the default value of the second SCS. For example, the second SCS may be configured for each of bandwidth parts (e.g., UL bandwidth parts). Also, the second SCS may be configured for each of serving cells. Also, the second SCS may be configured (e.g., separately configured) for each of PUCCH formats (e.g., PUCCH format 0, PUCCH format 1, and/or PUCCH format 3, etc.). Further, the second SCS may be configured (e.g., commonly configured) for more than one PUCCH formats (e.g., PUCCH format 0, PUCCH format 1, and/or PUCCH format 3, etc.).

Thus, as described above, the UE performs, based on the first SCS and the second SCS, PUCCH format 0 repetition.

Transmit Diversity

Transmit diversity (TxD) can also increase the reliability. With TxD, the PUCCH signal is transmitted on two antenna ports, each using a separate PUCCH PRB resource. For HARQ-ACK transmission with sequence based PUCCH format 0, the spatial orthogonal resource transmit diversity (SORTD) scheme may be supported for transmissions with two antenna ports (pϵ[p₀, p₁]). The UE can use the PUCCH resource for transmission of HARQ-ACK in a slot mapped to antenna port p. For transmission on antenna port p₀, the UE shall use a PUCCH resource that is configured or implicitly derived based on Control Channel Element (CCE) indexes of the scheduling DCI. For transmission on antenna port p₁, the UE can use the next PUCCH resource after the PUCCH resource used for antenna port p₀.

For a PUCCH format 0 configured with 1 PRB and TxD, the PUCCH resource for antenna port p₁ may have a starting PRB position that is the next adjacent PRB higher from the starting PRB of the PUCCH resource for antenna port p₀. For a PUCCH format 0 configured with k PRBs and TxD, the PUCCH resource for antenna port p₁ may have a starting PRB position that is k PRBs next to the starting PRB of the PUCCH resource for antenna port p₀.

For example, TxD for the PUCCH format 0 may be configured by using the RRC message. Namely, the gNB may transmit the RRC message including a parameter(s) indicating whether two antenna ports are configured for the PUCCH format 0. For example, the parameter may be configured for each of bandwidth parts (e.g., UL bandwidth parts). Also, the parameter may be configured for each of serving cells. Further, the parameter may be configured (e.g., separately configured) for each of PUCCH formats (e.g., PUCCH format 0, and/or PUCCH format 1, and/or PUCCH format 2, and/or PUCCH format 3, and/or PUCCH format 4, etc.). In addition, the parameter may be configured (e.g., commonly configured) for more than one PUCCH formats (e.g., PUCCH format 0, and/or PUCCH format 1, and/or PUCCH format 2, and/or PUCCH format 3, and/or PUCCH format 4, etc.).

The parameter may be configured (e.g., separately configured) for each of PUCCH resources (e.g., or PUCCH resource sets). Also, the parameter may be configured (e.g., commonly configured) for each of PUCCH resources (or PUCCH resource sets).

Transmit Power Control of Enhanced PUCCH Format 0

Another way to increase the reliability is to increase the transmit power. An enhanced PUCCH format 0 for URLLC may be configured with a higher transmit power than a conventional or “normal” PUCCH format 0.

In one method, a separate amplitude scaling factor β_{PUCCH,0_1} can be configured and mapped in sequence transmitted on the enhanced PUCCH format 0.

In another method, a new multiplier factor, or a delta value factor δ, can be configured for the enhanced PUCCH format 0, so that the amplitude scaling factor of the sequence transmitted on an enhanced PUCCH format 0 is defined by δβ_{PUCCH,0}, where β_{PUCCH,0} is the amplitude scaling factor configured for normal PUCCH transmission.

In all cases, the actual transmission power is limited by P_{CMAX,f,c}(i), which is the configured UE transmit power defined for carrier f of serving cell c in PUCCH transmission period i.

The PUCCH transmit diversity can be configured to a UE by higher layer signaling. If PUCCH TxD is configured, a delta TxD offset for transmit power control may also be configured. The candidate values of the delta TxD offset may be (−1 dB, 0 dB) as in current LTE specifications.

Configurations of Enhanced PUCCH Format 0 for URLLC

The above-mentioned methods can be configured independently or jointly. For example, to achieve 4 times redundancy compared with normal PUCCH format 0, the enhanced PUCCH format 0 may be configured with:
4 PRBs in each symbol, or
2 PRBs in each symbol and 2 times repetition in time domain, or
2 PRBs in each symbol with transmit diversity and 0 dB delta TxD offset value, or
2 PRBs in each symbol and a 3 dB power multiplier factor over normal PUCCH,
Etc.

To support more than one PRB, the PUCCH Format 0_1 resource configuration may have a new field on the number of PRBs. The parameter can be indicated as an integer number, e.g. any number between 1 and 8. The parameter may be indicated as an index of a set of pre-defined values, e.g. {1,2,4,8}. The number of potential values of the set determines the number of bits required to indicate the parameter.

-- A PUCCH Format 0_1 resource configuration
-- Corresponds to L1 parameter ‘PUCCH-F0_1-resource-config’

| | |
|---|---|
| PUCCH-format0_1 | SEQUENCE { |
| startingSymbolIndex | INTEGER(0..13), |
| nrofSymbols | ENUMERATED {n1, n2}, |
| startingPRB | |

INTEGER(0..maxNrofPhysicalResourceBlocks-1),

| | |
|---|---|
| nrofPRBs | PUCCH-F0_1-number-of-PRB, |
| frequencyHopping | BOOLEAN, |
| initialCyclicShift | INTEGER(0..11) |
| } | |

To support PUCCH repetition, several new parameters may be configured by higher layer signaling. In PUCCH-config, a new format format0_1 can be defined, and the interPUCCHFrequencyHopping and the nrofRepetitions can be configured. The number of PUCCH repetitions with the same PUCCH F0 corresponds to L1 parameter ‘PUCCH-F0-number-of-repetitions’. When the field is absent the UE applies the value n1. The set of values for nrofRepetitions is given by {n1, n2, n3, n4}, and may be set as {1,2,4,8}.

If the interPUCCHFrequencyHopping is enabled for PUCCH format 0 with repetitions, the frequencyHopping parameter in PUCCH format 0_1 configuration will be disabled.

PUCCH-Config information element

| | |
|---|---|
| -- ASN1START | |
| -- TAG-PUCCH-CONFIG-START | |
| PUCCH-Config ::= | SEQUENCE { |

-- PUCCH resource sets (see 38.213 9.2)

| | |
|---|---|
| resourceSets | SEQUENCE (SIZE (1..FFS_Value)) OF |
| PUCCH-ResourceSet OPTIONAL, | |
| format0_1 | SetupRelease { SEQUENCE { |

-- Enabling inter-PUCCH frequency hopping when PUCCH Format 0 is
repetead continuous multiple times in time domain.

| | |
|---|---|
| interPUCCHFrequencyHopping | ENUMERATED {enabled} |

```
        -- Number of PUCCH repetitions with the same PUCCH F0. When the
field is absent the UE applies the value n1.
        -- Corresponds to L1 parameter ‘PUCCH-F0-number-of-repetitions’
        -- {n1, n2, n3, n4} may be set as {1,2,4,8}
```

| | |
|---|---|
| nrofRepetitions | ENUMERATED {n1,n2,n3,n4} |
| } } | |

The support of PUCCH with two antenna port transmission, i.e. transmit diversity, may be a UE capability. If the UE supports transmit diversity, the UE may be configured by the gNB with two antenna port transmission for enhanced PUCCH formats. Once configured, for transmission on antenna port p₀, the UE may use a PUCCH resource that is configured or implicitly derived based on CCE indexes of the scheduling DCI. For transmission on antenna port p₁, the UE shall use the next PUCCH resource after the PUCCH resource used for antenna port p₀.

The default transmit power of an enhanced PUCCH format 0 may be higher than a conventional or “normal” PUCCH format 0. The UE may be configured by a gNB with a separate amplitude scaling factor β_{PUCCH,0_1}, or be configured with a delta value over the normal PUCCH format 0.

In summary, an enhanced short PUCCH format 0 for URLLC may be configured with a different set of parameters from normal PUCCH format 0 for a UE. The resource and location of short PUCCH may be semi-statically configured, and dynamically transmitted based on DL URLLC reception.

As described above, the UE may transmit by using the enhanced short PUCCH format 0, HARQ-ACK corresponding to URLLC data transmission (e.g., URLLC PDSCH transmission). Here, the UE may transmit by using the conventional or “normal” PUCCH format 0, HARQ-ACK corresponding to data transmission (e.g., PDSCH transmission) other than URLLC data transmission. Namely, the UE may use the enhanced short PUCCH format 0 in a case that HARQ-ACK corresponding to URLLC data transmission is transmitted. Namely, URLLC data transmission (e.g., URLLC PDSCH transmission) may be identified for HARQ-ACK transmission using the enhanced short PUCCH format 0.

For example, the gNB may transmit by using the RRC message, a parameter used for identifying whether or not the PDSCH is corresponding to URLLC data transmission. The parameter may be associated with PDSCH transmission mode(s). Namely, the UE may use the enhanced short PUCCH format 0 to transmit HARQ-ACK corresponding to the PDSCH that is configured with URLLC data transmission. Also, the UE may use the conventional or “normal” PUCCH format 0 to transmit HARQ-ACK corresponding to the PDSCH that is not configured with URLLC data transmission. For example, if two antenna ports (e.g., TxD) are configured (as described above), the UE uses the two antenna ports to transmit HARQ-ACK corresponding to the PDSCH that is configured with URLLC data transmission. Here, even if two antenna ports (e.g., TxD) are configured (as described above), the UE uses one antenna port to transmit HARQ-ACK corresponding to the PDSCH that is not configured with URLLC data transmission.

Also, the PDSCH for URLLC data transmission may be scheduled (e.g., identified) by using DCI (e.g., the DCI format(s)) scrambled with Y-RNTI different from the C-RNTI. Namely, the UE may use the enhanced short PUCCH format 0 to transmit HARQ-ACK corresponding to the PDSCH transmission scheduled by using the DCI scrambled with Y-RNTI. Also, the UE may use the conventional or “normal” PUCCH format 0 to transmit HARQ-ACK corresponding to the PDSCH transmission scheduled by using the DCI scrambled with C-RNTI. For example, if two antenna ports (e.g., TxD) are configured (as described above), the UE uses the two antenna ports to transmit HARQ-ACK corresponding to the PDSCH transmission scheduled by using the DCI scrambled with Y-RNTI. Here, even if two antenna ports (e.g., TxD) are configured (as described above), the UE uses one antenna port to transmit HARQ-ACK corresponding to the PDSCH transmission scheduled by using the DCI scrambled with C-RNTI. Here, the DCI scrambled with Y-RNTI may be detected only in UE-specific search space. And, the DCI scrambled with C-RNTI may be detected only in UE-specific search space and common search space.

Also, a timing(s) (e.g., a position(s) of a slot(s) and/or a symbol(s), a periodicity, and/or an offset value(s)) for the PDSCH for URLLC data transmission may be configured by using the RRC message. Namely, the UE may use the enhanced short PUCCH format 0 to transmit HARQ-ACK corresponding to the PDSCH transmission in the configured timing(s). Also, the UE may use the conventional or “normal” PUCCH format 0 to transmit HARQ-ACK corresponding to the PDSCH transmission in a timing(s) other than the configured timing(s). For example, if two antenna ports (e.g., TxD) are configured (as described above), the UE uses the two antenna ports to transmit HARQ-ACK corresponding to the PDSCH transmission in the configured timing(s). Here, even if two antenna ports (e.g., TxD) are configured (as described above), the UE uses one antenna port to transmit HARQ-ACK corresponding to the PDSCH transmission in the timing(s) other than the configured timing(s).

The PDSCH for URLLC data transmission may be identified by using CQI table(s) (e.g., CQI/MCS table(s)) and/or Block Error Rate (BLER) target(s). For example, the gNB may transmit by using the RRC message, a parameter used for indicating which CQI table(s) is used for CQI calculation. Also, the gNB may transmit by using the RRC message, a parameter used for indicating BLER target that the UE assumes in CQI calculation. Namely, first CQI table and/or first BLER target associated with the PDSCH corresponding to URLLC data transmission may be defined. Also, second CQI table and/or second BLER for the PDSCH corresponding to data transmission other than URLLC data transmission may be defined. And, the UE may use the enhanced short PUCCH format 0 to transmit HARQ-ACK corresponding to the PDSCH transmission associated with the first CQI table and/or the first BLER target. Further, the UE may use the conventional or “normal” PUCCH format 0 to transmit HARQ-ACK corresponding to the PDSCH transmission associated with the second CQI and the second BLER target. For example, if two antenna ports (e.g., TxD) are configured (as described above), the UE uses the two antenna ports to transmit HARQ-ACK corresponding to the PDSCH transmission associated with the first CQI table and/or the first BLER target. Here, even if two antenna ports (e.g., TxD) are configured (as described above), the UE uses one antenna port to transmit HARQ-ACK corresponding to the PDSCH transmission associated with the second CQI table and/or the second BLER target.

The UE may be configured with separate PUCCH resource set for enhanced PUCCH format 0 from the conventional or “normal” PUCCH format.

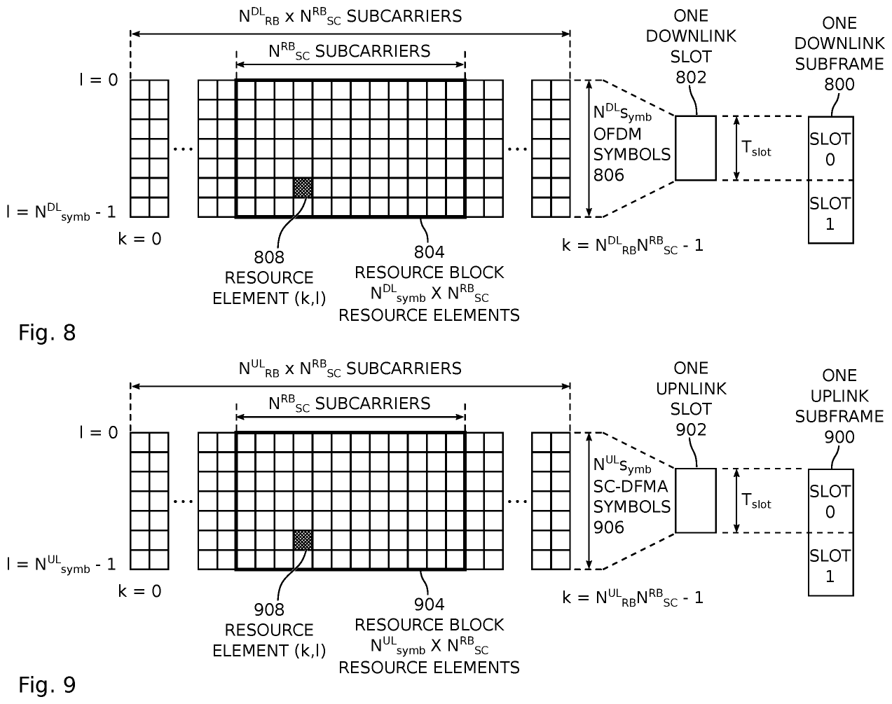

FIG. 8 is a diagram illustrating one example of a resource grid for the downlink. The resource grid illustrated in FIG. 8 may be utilized in some implementations of the systems and methods disclosed herein. More detail regarding the resource grid is given in connection with FIG. 1.

In FIG. 8, one downlink subframe 800 may include two downlink slots 802. N^{DL}_{RB} is downlink bandwidth configuration of the serving cell, expressed in multiples of N^{RB}_{sc}, where N^{RB}_{sc} is a resource block 804 size in the frequency domain expressed as a number of subcarriers, and N^{DL}_{symb} is the number of OFDM symbols 806 in a downlink slot 802. A resource block 804 may include a number of resource elements (RE) 808.

For a PCell, N^{DL}_{RB} is broadcast as a part of system information. For an SCell (including a license assisted access (LAA) SCell), N^{DL}_{RB} is configured by a RRC message dedicated to a UE 102. For PDSCH mapping, the available RE 808 may be the RE 808 whose index l fulfils l≥l_{data,start} and/or l_{data,end}≥l in a subframe.

In the downlink, the OFDM access scheme with cyclic prefix (CP) may be employed, which may be also referred to as CP-OFDM. In the downlink, PDCCH, enhanced downlink physical control channel (EPDCCH), PDSCH and the like may be transmitted. A downlink radio frame may consist of multiple pairs of downlink resource blocks (RBs) which is also referred to as physical resource blocks (PRBs). The downlink RB pair is a unit for assigning downlink radio resources, defined by a predetermined bandwidth (RB bandwidth) and a time slot. The downlink RB pair consists of two downlink RBs that are continuous in the time domain.

The downlink RB consists of twelve sub-carriers in the frequency domain and seven (for normal CP) or six (for extended CP) OFDM symbols in time domain. A region defined by one sub-carrier in the frequency domain and one OFDM symbol in the time domain is referred to as a resource element (RE) and is uniquely identified by the index pair (k,l) in a slot, where k and l are indices in the frequency and time domains, respectively. While downlink subframes in one component carrier (CC) are discussed herein, downlink subframes are defined for each CC and downlink subframes are substantially in synchronization with each other among CCs.

FIG. 9 is a diagram illustrating one example of a resource grid for the uplink. The resource grid illustrated in FIG. 9 may be utilized in some implementations of the systems and methods disclosed herein. More detail regarding the resource grid is given in connection with FIG. 1.

In FIG. 9, one uplink subframe 900 may include two uplink slots 902. N^{UL}_{RB} is uplink bandwidth configuration of the serving cell, expressed in multiples of N^{RB}_{sc}, where N^{RB}_{sc} is a resource block 904 size in the frequency domain expressed as a number of subcarriers, and N^{UL}_{symb} is the number of SC-FDMA symbols 906 in an uplink slot 902. A resource block 904 may include a number of resource elements (RE) 908.

For a PCell, N^{UL}_{RB} is broadcast as a part of system information. For an SCell (including an LAA SCell), N^{UL}_{RB} is configured by a RRC message dedicated to a UE 102.

In the uplink, in addition to CP-OFDM, a Single-Carrier Frequency Division Multiple Access (SC-FDMA) access scheme may be employed, which is also referred to as Discrete Fourier Transform-Spreading OFDM (DFT-S-OFDM). In the uplink, PUCCH, PDSCH, physical random access channel (PRACH) and the like may be transmitted. An uplink radio frame may consist of multiple pairs of uplink resource blocks. The uplink RB pair is a unit for assigning uplink radio resources, defined by a predetermined bandwidth (RB bandwidth) and a time slot. The uplink RB pair consists of two uplink RBs that are continuous in the time domain.

The uplink RB may consist of twelve sub-carriers in the frequency domain and seven (for normal CP) or six (for extended CP) OFDM/DFT-S-OFDM symbols in the time domain. A region defined by one sub-carrier in the frequency domain and one OFDM/DFT-S-OFDM symbol in the time domain is referred to as a RE and is uniquely identified by the index pair (k,l) in a slot, where k and l are indices in the frequency and time domains respectively. While uplink subframes in one component carrier (CC) are discussed herein, uplink subframes are defined for each CC.

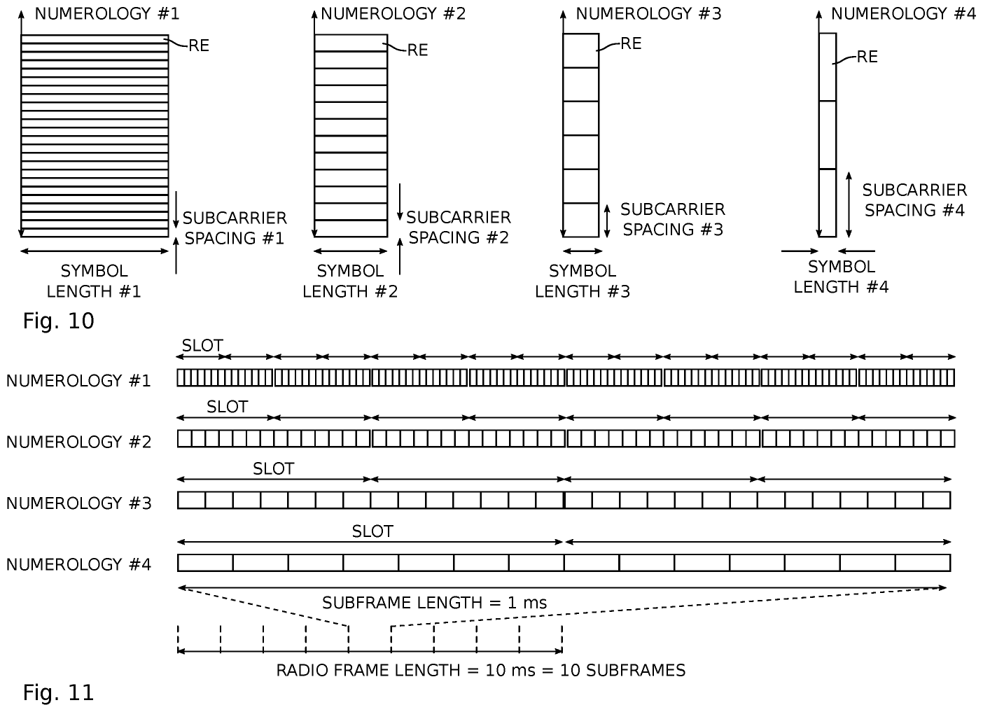

FIG. 10 is a diagram illustrating examples of several numerologies. The numerology #1 may be a basic numerology. For example, a RE of the basic numerology is defined with subcarrier spacing of 15 kHz in frequency domain and 2048 Ts+CP length (e.g. 160 Ts or 144 Ts) in time domain, where Ts denotes a baseband sampling time unit defined as 1/(15000*2048) seconds. For the i-th numerology, the subcarrier spacing may be equal to 15*2¹ and the effective OFDM symbol length 2048*2⁻ⁱ*Ts. It may cause the symbol length is 2048*2⁻ⁱ*Ts+CP length (e.g. 160*2⁻ⁱ*Ts or 144*2⁻ⁱ*Ts). In other words, the subcarrier spacing of the i+1-th numerology is a double of the one for the i-th numerology, and the symbol length of the i+1-th numerology is a half of the one for the i-th numerology. The system may support a number of numerologies. Furthermore, the system does not have to support all of the 0-th to the I-th numerologies, i=0, 1, . . . , I.

FIG. 11 is a diagram illustrating examples of subframe structures for the numerologies that are shown in FIG. 10. Given that a slot consists of N^{DL}_{symb} (or N^{UL}_{symb})=7 symbols, the slot length of the i+1-th numerology is a half of the one for the i-th numerology, and eventually the number of slots in a subframe (i.e., 1 ms) becomes double. It may be noted that a radio frame may consists of 10 subframes, and the radio frame length may be equal to 10 ms.

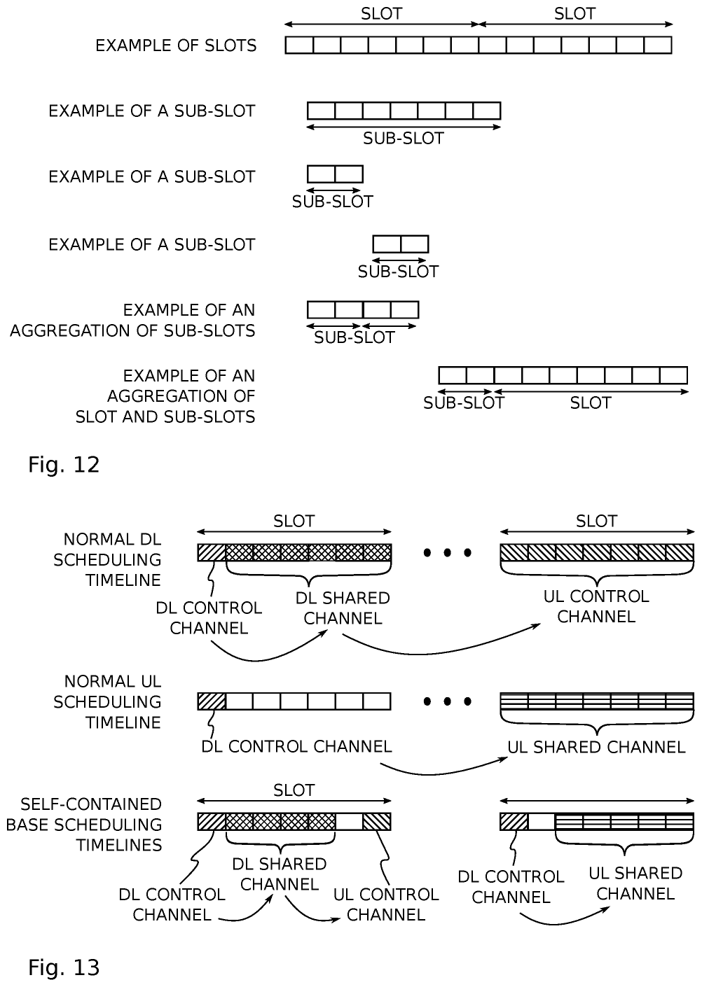

FIG. 12 is a diagram illustrating examples of slots and sub-slots. If sub-slot is not configured by higher layer, the UE 102 and the eNB/gNB 160 may only use a slot as a scheduling unit. More specifically, a given transport block may be allocated to a slot. If the sub-slot is configured by higher layer, the UE 102 and the eNB/gNB 160 may use the sub-slot as well as the slot. The sub-slot may consist of one or more OFDM symbols. The maximum number of OFDM symbols that constitute the sub-slot may be N^{DL}_{symb}−1 (or N^{UL}_{symb}−1).

The sub-slot length may be configured by higher layer signaling. Alternatively, the sub-slot length may be indicated by a physical layer control channel (e.g. by DCI format).

The sub-slot may start at any symbol within a slot unless it collides with a control channel. There could be restrictions of mini-slot length based on restrictions on starting position. For example, the sub-slot with the length of N^{DL}_{symb}−1 (or N^{UL}_{symb}−1) may start at the second symbol in a slot. The starting position of a sub-slot may be indicated by a physical layer control channel (e.g. by DCI format). Alternatively, the starting position of a sub-slot may be derived from information (e.g. search space index, blind decoding candidate index, frequency, and/or time resource indices, PRB index, a control channel element index, control channel element aggregation level, an antenna port index, etc.) of the physical layer control channel which schedules the data in the concerned sub-slot.

In cases when the sub-slot is configured, a given transport block may be allocated to either a slot, a sub-slot, aggregated sub-slots, or aggregated sub-slot(s) and slot. This unit may also be a unit for HARQ-ACK bit generation.

FIG. 13 is a diagram illustrating examples of scheduling timelines. For a normal DL scheduling timeline, DL control channels are mapped the initial part of a slot. The DL control channels schedule DL shared channels in the same slot. HARQ-ACKs for the DL shared channels (i.e. HARQ-ACKs each of which indicates whether or not transport block in each DL shared channel is detected successfully) are reported via UL control channels in a later slot. In this instance, a given slot may contain either one of DL transmission and UL transmission. For a normal UL scheduling timeline, DL control channels are mapped the initial part of a slot. The DL control channels schedule UL shared channels in a later slot. For these cases, the association timing (time shift) between the DL slot and the UL slot may be fixed or configured by higher layer signaling. Alternatively, it may be indicated by a physical layer control channel (e.g. the DL assignment DCI format, the UL grant DCI format, or another DCI format such as UE-common signaling DCI format which may be monitored in common search space).

For a self-contained base DL scheduling timeline, DL control channels are mapped to the initial part of a slot. The DL control channels schedule DL shared channels in the same slot. HARQ-ACKs for the DL shared channels are reported in UL control channels which are mapped at the ending part of the slot. For a self-contained base UL scheduling timeline, DL control channels are mapped to the initial part of a slot. The DL control channels schedule UL shared channels in the same slot. For these cases, the slot may contain DL and UL portions, and there may be a guard period between the DL and UL transmissions.

The use of a self-contained slot may be based upon a configuration of the self-contained slot. Alternatively, the use of a self-contained slot may be based upon a configuration of the sub-slot. Yet alternatively, the use of a self-contained slot may be upon a configuration of a shortened physical channel (e.g. PDSCH, PUSCH, PUCCH, etc.).

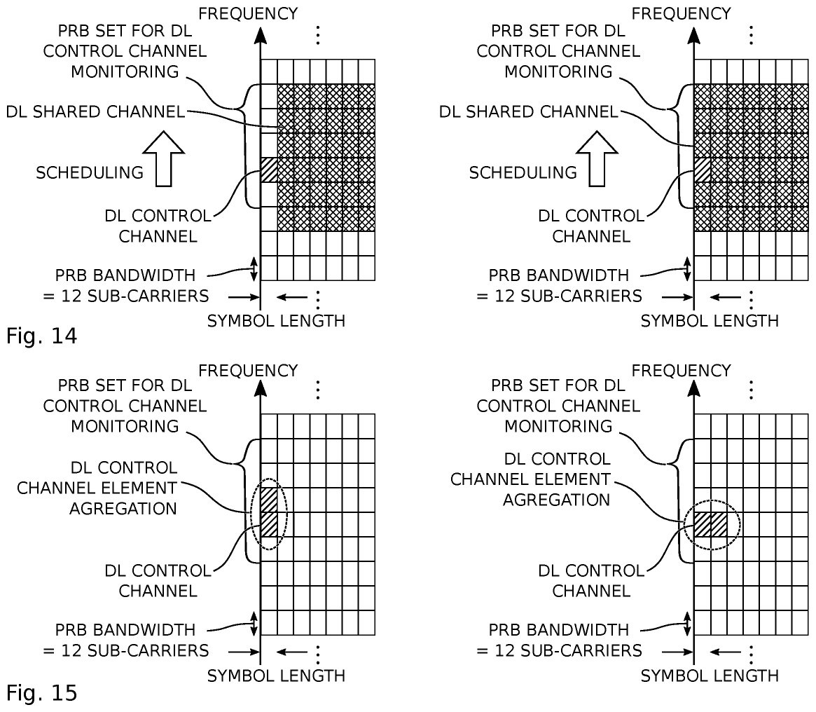

FIG. 14 is a diagram illustrating examples of DL control channel monitoring regions. One or more sets of PRB(s) may be configured for DL control channel monitoring. In other words, a control resource set is, in the frequency domain, a set of PRBs within which the UE 102 attempts to blindly decode downlink control information, where the PRBs may or may not be frequency contiguous, a UE 102 may have one or more control resource sets, and one DCI message may be located within one control resource set. In the frequency-domain, a PRB is the resource unit size (which may or may not include demodulation reference signal (DM-RS)) for a control channel. A DL shared channel may start at a later OFDM symbol than the one(s) which carries the detected DL control channel. Alternatively, the DL shared channel may start at (or earlier than) an OFDM symbol than the last OFDM symbol which carries the detected DL control channel. In other words, dynamic reuse of at least part of resources in the control resource sets for data for the same or a different UE 102, at least in the frequency domain may be supported.

FIG. 15 is a diagram illustrating examples of DL control channel which consists of more than one control channel elements. When the control resource set spans multiple OFDM symbols, a control channel candidate may be mapped to multiple OFDM symbols or may be mapped to a single OFDM symbol. One DL control channel element may be mapped on REs defined by a single PRB and a single OFDM symbol. If more than one DL control channel elements are used for a single DL control channel transmission, DL control channel element aggregation may be performed.

The number of aggregated DL control channel elements is referred to as DL control channel element aggregation level. The DL control channel element aggregation level may be 1 or 2 to the power of an integer. The gNB 160 may inform a UE 102 of which control channel candidates are mapped to each subset of OFDM symbols in the control resource set. If one DL control channel is mapped to a single OFDM symbol and does not span multiple OFDM symbols, the DL control channel element aggregation is performed within an OFDM symbol, namely multiple DL control channel elements within an OFDM symbol are aggregated. Otherwise, DL control channel elements in different OFDM symbols can be aggregated.

FIG. 16 is a diagram illustrating examples of UL control channel structures. UL control channel may be mapped on REs which are defined a PRB and a slot in the frequency and time domains, respectively. This UL control channel may be referred to as a long format (or just the 1st format). UL control channels may be mapped on REs on a limited OFDM symbols in time domain. This may be referred to as a short format (or just the 2nd format). The UL control channels with a short format may be mapped on REs within a single PRB. Alternatively, the UL control channels with a short format may be mapped on REs within multiple PRBs. For example, interlaced mapping may be applied, namely the UL control channel may be mapped to every N PRBs (e.g. 5 or 10) within a system bandwidth.

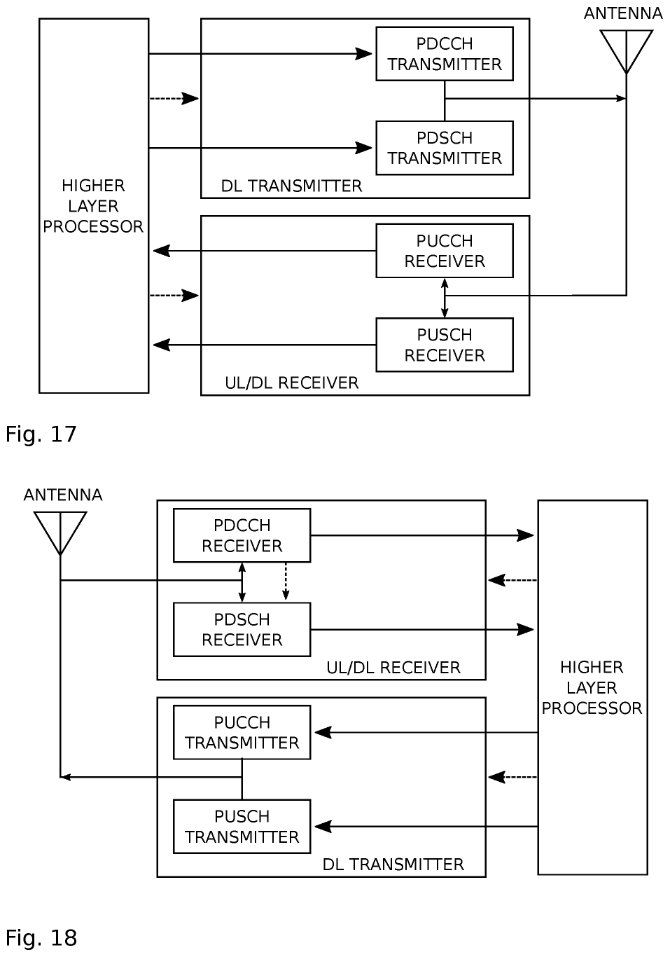

FIG. 17 is a block diagram illustrating one implementation of a gNB 1160. The gNB 1160 may include a higher layer processor, a DL transmitter, a UL/DL receiver, and antennas. The DL transmitter may include a PDCCH transmitter and a PDSCH transmitter. The UL/DL receiver may include a PUCCH receiver and a PUSCH receiver. The higher layer processor may manage physical layer's behaviors (the DL transmitter's and the UL/DL receiver's behaviors) and provide higher layer parameters to the physical layer. The higher layer processor may obtain transport blocks from the physical layer. The higher layer processor may send/acquire higher layer messages such as an RRC message and MAC message to/from a UE's higher layer. The higher layer processor may provide the PDSCH transmitter transport blocks and provide the PDCCH transmitter transmission parameters related to the transport blocks. The UL/DL receiver may receive multiplexed uplink physical channels and uplink physical signals via receiving antennas and de-multiplex them. The PUCCH receiver may provide the higher layer processor UCI. The PUSCH receiver may provide the higher layer processor received transport blocks.

FIG. 18 is a block diagram illustrating one implementation of a UE 1202. The UE 1202 may include a higher layer processor, a UL transmitter, a DL receiver, and antennas. The DL transmitter may include a PUCCH transmitter and a PUSCH transmitter. The UL/DL receiver may include a PDCCH receiver and a PDSCH receiver. The higher layer processor may manage physical layer's behaviors (the DL transmitter's and the UL/DL receiver's behaviors) and provide higher layer parameters to the physical layer. The higher layer processor may obtain transport blocks from the physical layer. The higher layer processor may send/acquire higher layer messages such as an RRC message and MAC message to/from a UE's higher layer. The higher layer processor may provide the PUSCH transmitter transport blocks and provide the PUCCH transmitter UCI. The UL/DL receiver may receive multiplexed downlink physical channels and downlink physical signals via receiving antennas and de-multiplex them. The PDCCH receiver may provide the higher layer processor DCI. The PDSCH receiver may provide the higher layer processor received transport blocks.

It should be noted that names of physical channels described herein are examples. The other names such as “New Radio (NR)PDCCH, NRPDSCH, NRPUCCH and NRPUSCH”, “new Generation-(G)PDCCH, GPDSCH, GPUCCH and GPUSCH” or the like can be used.

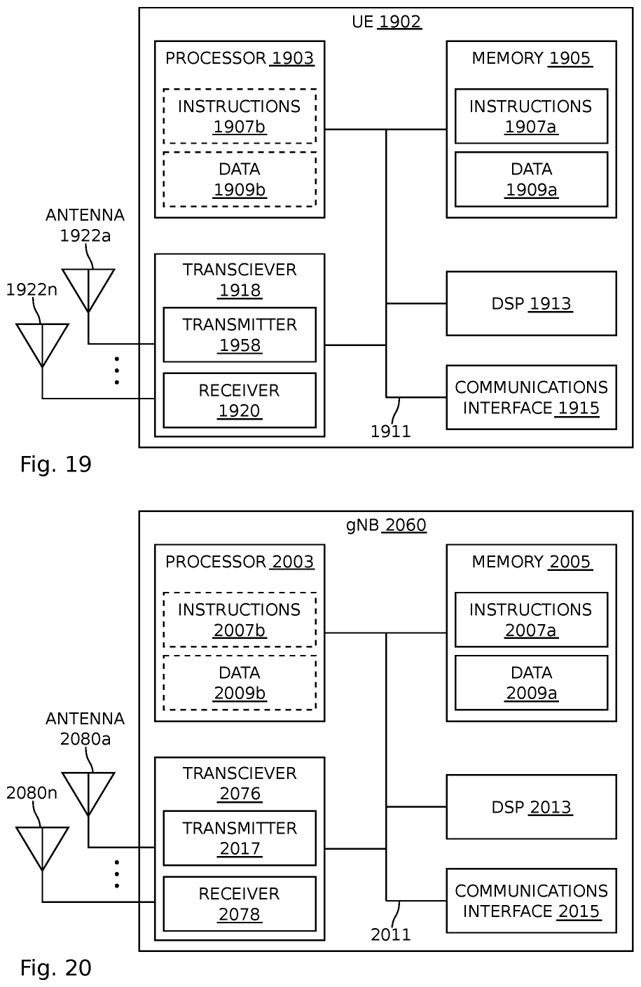

FIG. 19 illustrates various components that may be utilized in a UE 1902. The UE 1902 described in connection with FIG. 19 may be implemented in accordance with the UE 102 described in connection with FIG. 1. The UE 1902 includes a processor 1903 that controls operation of the UE 1902. The processor 1903 may also be referred to as a central processing unit (CPU). Memory 1905, which may include read-only memory (ROM), random access memory (RAM), a combination of the two or any type of device that may store information, provides instructions 1907a and data 1909a to the processor 1903. A portion of the memory 1905 may also include non-volatile random access memory (NVRAM). Instructions 1907b and data 1909b may also reside in the processor 1903. Instructions 1907b and/or data 1909b loaded into the processor 1903 may also include instructions 1907a and/or data 1909a from memory 1905 that were loaded for execution or processing by the processor 1903. The instructions 1907b may be executed by the processor 1903 to implement the methods described above.

The UE 1902 may also include a housing that contains one or more transmitters 1958 and one or more receivers 1920 to allow transmission and reception of data. The transmitter(s) 1958 and receiver(s) 1920 may be combined into one or more transceivers 1918. One or more antennas 1922a-n are attached to the housing and electrically coupled to the transceiver 1918.

The various components of the UE 1902 are coupled together by a bus system 1911, which may include a power bus, a control signal bus and a status signal bus, in addition to a data bus. However, for the sake of clarity, the various buses are illustrated in FIG. 19 as the bus system 1911. The UE 1902 may also include a digital signal processor (DSP) 1913 for use in processing signals. The UE 1902 may also include a communications interface 1915 that provides user access to the functions of the UE 1902. The UE 1902 illustrated in FIG. 19 is a functional block diagram rather than a listing of specific components.

FIG. 20 illustrates various components that may be utilized in a gNB 2060. The gNB 2060 described in connection with FIG. 20 may be implemented in accordance with the gNB 160 described in connection with FIG. 1. The gNB 2060 includes a processor 2003 that controls operation of the gNB 2060. The processor 2003 may also be referred to as a CPU. Memory 2005, which may include ROM, RAM, a combination of the two or any type of device that may store information, provides instructions 2007a and data 2009a to the processor 2003. A portion of the memory 2005 may also include NVRAM. Instructions 2007b and data 2009b may also reside in the processor 2003. Instructions 2007b and/or data 2009b loaded into the processor 2003 may also include instructions 2007a and/or data 2009a from memory 2005 that were loaded for execution or processing by the processor 2003. The instructions 2007b may be executed by the processor 2003 to implement the methods described above.

The gNB 2060 may also include a housing that contains one or more transmitters 2017 and one or more receivers 2078 to allow transmission and reception of data. The transmitter(s) 2017 and receiver(s) 2078 may be combined into one or more transceivers 2076. One or more antennas 2080a-n are attached to the housing and electrically coupled to the transceiver 2076.

The various components of the gNB 2060 are coupled together by a bus system 2011, which may include a power bus, a control signal bus and a status signal bus, in addition to a data bus. However, for the sake of clarity, the various buses are illustrated in FIG. 20 as the bus system 2011. The gNB 2060 may also include a DSP 2013 for use in processing signals. The gNB 2060 may also include a communications interface 2015 that provides user access to the functions of the gNB 2060. The gNB 2060 illustrated in FIG. 20 is a functional block diagram rather than a listing of specific components.

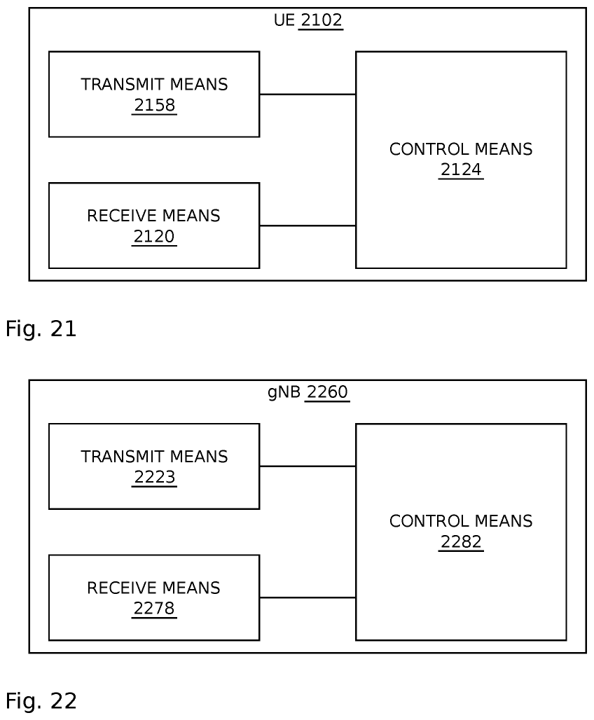

FIG. 21 is a block diagram illustrating one implementation of a UE 2102 in which systems and methods for a long PUCCH design for 5G NR operations may be implemented. The UE 2102 includes transmit means 2158, receive means 2120 and control means 2124. The transmit means 2158, receive means 2120 and control means 2124 may be configured to perform one or more of the functions described in connection with FIG. 1 above. FIG. 19 above illustrates one example of a concrete apparatus structure of FIG. 21. Other various structures may be implemented to realize one or more of the functions of FIG. 1. For example, a DSP may be realized by software.

FIG. 22 is a block diagram illustrating one implementation of a gNB 2260 in which systems and methods for a long PUCCH design for 5G NR operations may be implemented. The gNB 2260 includes transmit means 2217, receive means 2278 and control means 2282. The transmit means 2217, receive means 2278 and control means 2282 may be configured to perform one or more of the functions described in connection with FIG. 1 above. FIG. 20 above illustrates one example of a concrete apparatus structure of FIG. 22. Other various structures may be implemented to realize one or more of the functions of FIG. 1. For example, a DSP may be realized by software.

With reference to FIG. 19, among other supporting figures, a mobile station 1902 may comprise receiving circuitry 1920 configured to receive a RRC message with a first set of transmission power parameters and a second set of transmission power parameters. Transmitting circuitry 1958 is then configured to transmit the UCI using the PUCCH format 0, with the UCI being transmitted based upon either the first set of transmission power parameters or the second set of transmission power parameters. The selection of which parameter is responsive to the type of RNTI used for scheduling PDSCH communications. The use of either 1 bit or 2 bits is supported for the UCI using the PUCCH format 0, and a low-Peak to Average Power Ratio (low-PAPR) sequence is used for the PUCCH format 0. The transmitting circuitry 1958 transmits using the first set of transmission power parameters for the UCI when a C-RNTI is used for scheduling the PDSCH. Otherwise, the transmitting circuitry 1958 transmits using the second set of transmission power parameters for the UCI when a RNTI, different from a C-RNTI, is used for scheduling of the PDSCH.

Referencing FIG. 20, among other supporting figures, the base station 2060 comprises transmitting circuitry 2017 configured to transmit a RRC message with a first set of transmission power parameters and a second set of transmission power parameters. Receiving circuitry 2078 is configured to receive the UCI using the PUCCH format 0, with the UCI being received with a power based upon either the first set of transmission power parameters or the second set of transmission power parameters. The parameter selection is responsive to the type of RNTI used for PDSCH communications. Again, the use of either 1 bit or 2 bits is supported for the UCI using the PUCCH format 0, and the low-PAPR sequence is used for the PUCCH format 0. The receiving circuitry 2078 receives the UCI using the first set of transmission power parameters when a C-RNTI is used for scheduling of the PDSCH. Alternatively, the receiving circuitry 2078 receives the UCI using the second set of transmission power parameters when a RNTI, different from a C-RNTI, is used for scheduling of the PDSCH.

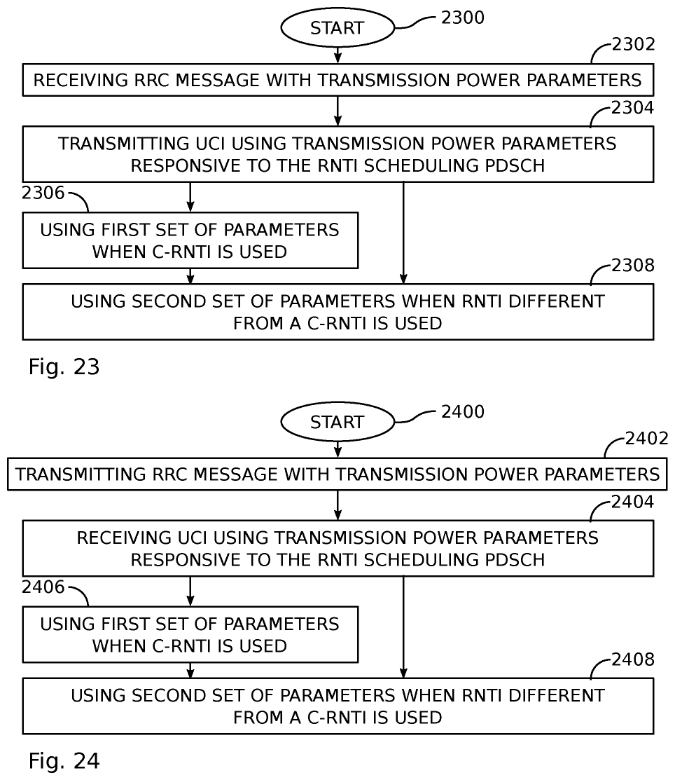

FIG. 23 is a flowchart illustrating a mobile station communication method. The method starts at Step 2300. In Step 2302 a RRC message is received by the mobile station with a first set of transmission power parameters and a second set of transmission power parameters. Step 2304 transmits a UCI using the PUCCH format 0, using either the first set of transmission power parameters or the second set of transmission power parameters. The selection of the transmission power parameters is responsive to the type of RNTI used for scheduling physical downline shared channel (PDSCH) communications. The number of bits supported for the UCI using the PUCCH format 0 is either 1 bit or 2 bits, and a low-PAPR sequence is also used for the PUCCH format 0. In Step 2306 the first set of transmission power parameters for the transmission of the UCI, when a C-RNTI is used for scheduling of the PDSCH. In Step 2308 the second set of transmission power parameters for the transmission of the UCI, when a RNTI, different from a C-RNTI, is used for scheduling of a PDSCH.

FIG. 24 is a flowchart illustrating a base station communication method. The method begins at Step 2400. In Step 2402 a RRC message is transmitted by the base station with a first set of transmission power parameters and a second set of transmission power parameters. In Step 2404 UCI is received using the PUCCH format 0, with the UCI being received with a power based upon either the first set of transmission power parameters or the second set of transmission power parameters, The selection of transmission power parameters is responsive to the type of RNTI used for PDSCH communications. Either 1 bit or 2 bits is supported for the UCI using the PUCCH format 0, and a low-PAPR sequence is also used for the PUCCH format 0. In Step 2406 the first set of transmission power parameters is used for the reception of the UCI, when a C-RNTI is used for scheduling the PDSCH. Alternatively, in Step 2308 the second set of transmission power parameters is used for the reception of the UCI, when a RNTI, different from a C-RNTI, is used for scheduling of a PDSCH.

Again referencing FIG. 19, among other supporting diagrams, in another aspect the mobile station 1902 comprises receiving circuitry 1920 configured to receive a RRC message including first information used for configuring a number of repetitions in a time domain for a PUCCH format 0. Transmitting circuitry 1958 is configured to transmit UCI using the PUCCH format 0. As above, either 1 bit or 2 bits is supported for the UCI using the PUCCH format 0, a low-PAPR sequence is also used for the PUCCH format 0. If a first number of repetitions has been previously configured, the transmitting circuitry 1958 repeatedly transmits the UCI using the PUCCH format 0 in continuous symbols based on the first number of repetitions.

The mobile station 1902 the receiving circuitry 1920 may also, or alternatively receive a second information used to enable frequency hopping in a frequency domain for the PUCCH format 0. If hopping in the frequency is enabled, the transmitting circuitry 1958 transmits the UCI using the PUCCH format 0 with hopping in the frequency domain, where the number of repetitions in the time domain is applied per hop in the frequency domain.

Referencing FIG. 20, among other possible supporting figures, in one aspect the base station 2060 comprises transmitting circuitry 2017 configured to transmit a RRC message including first information used for configuring a number of repetitions in a time domain for the PUCCH format 0. The receiving circuitry 2078 is configured to receive UCI using the PUCCH format 0, where either 1 bit or 2 bits is supported for the UCI using the PUCCH format 0, and a low-PAPR sequence is also used for the PUCCH format 0. If a first number of repetitions has been previously configured, the receiving circuitry 2078 repeatedly receives the UCI using the PUCCH format 0 in continuous symbols based on the first number of repetitions.

Alternatively or in addition, the base station 2060 transmitting circuitry 2017 is configured to transmit a RRC message including second information used for enabling hopping in a frequency domain for the PUCCH format 0. Then, the receiving circuitry 2078, if hopping in the frequency is enabled, receives the UCI using the PUCCH format 0 with hopping in the frequency domain, where the number of repetitions in the time domain is applied per hop in the frequency domain.

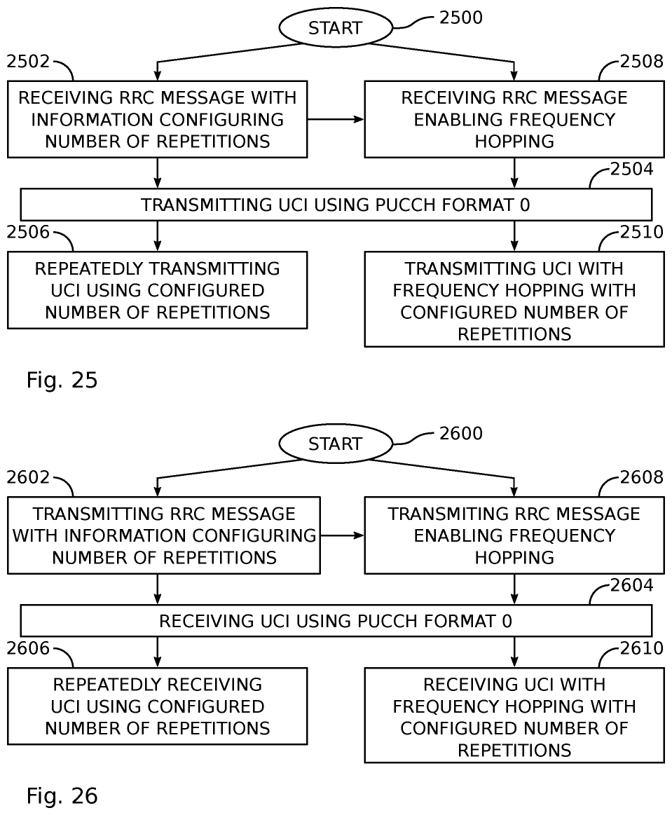

FIG. 25 is a flowchart illustrating an alternative mobile station communication method. The method starts at Step 2500. In Step 2502 the mobile station receives a RRC message including first information used for configuring a number of repetitions in a time domain for the PUCCH format 0. Step 2504 transmits UCI using the PUCCH format 0, where the use of either 1 or 2 bits is supported, along with the use of a low-PAPR sequence for the PUCCH format 0. In a case when a first number of repetitions has been previously configured, Step 2506 repeatedly transmits the UCI using the PUCCH format 0 in continuous symbols based on the first number of repetitions.

In Step 2508 the mobile station receives a RRC message including second information used for enabling of a hopping in a frequency domain for the PUCCH format 0. If hopping in the frequency is enabled, Step 2510 transmits the UCI using the PUCCH format 0 with hopping in the frequency domain, where the number of repetitions in the time domain is applied per hop in the frequency domain.

FIG. 26 is a flowchart illustrating an alternative base station communication method. The method begins at Step 2600. In Step 2602 the base station transmits a RRC message including first information used for configuring a number of repetitions in a time domain for the PUCCH format 0. Step 2604 receives UCI using the PUCCH format 0, supported using either 1 or 2 bits, and with a low-PAPR sequence for the PUCCH format 0. In the case that a first number of repetitions has been previously configured, Step 2606 repeatedly receives the UCI using the PUCCH format 0 in continuous symbols based on the first number of repetitions.

Alternatively or in addition, in Step 2608 the base station may transmit a RRC message including second information used for enabling hopping in a frequency domain for the PUCCH format 0. In the case that hopping in the frequency is enabled, Step 2610 receives the UCI using the PUCCH format 0 with hopping in the frequency domain, where the number of repetitions in the time domain is applied per hop in the frequency domain.

The term “computer-readable medium” refers to any available medium that can be accessed by a computer or a processor. The term “computer-readable medium,” as used herein, may denote a computer- and/or processor-readable medium that is non-transitory and tangible. By way of example, and not limitation, a computer-readable or processor-readable medium may comprise random access memory (RAM), read-only memory (ROM), electrically erasable programmable memory (EEPROM), CD-ROM or other optical disk storage, magnetic disk storage or other magnetic storage devices, or any other medium that can be used to carry or store desired program code in the form of instructions or data structures and that can be accessed by a computer or processor. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

It should be noted that one or more of the methods described herein may be implemented in and/or performed using hardware. For example, one or more of the methods described herein may be implemented in and/or realized using a chipset, an application-specific integrated circuit (ASIC), a large-scale integrated circuit (LSI) or integrated circuit, etc.

Each of the methods disclosed herein comprises one or more steps or actions for achieving the described method. The method steps and/or actions may be interchanged with one another and/or combined into a single step without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the systems, methods, and apparatus described herein without departing from the scope of the claims.

A program running on the gNB 160 or the UE 102 according to the described systems and methods is a program (a program for causing a computer to operate) that controls a CPU and the like in such a manner as to realize the function according to the described systems and methods. Then, the information that is handled in these apparatuses is temporarily stored in a RAM while being processed. Thereafter, the information is stored in various ROMs or HDDs, and whenever necessary, is read by the CPU to be modified or written. As a recording medium on which the program is stored, among a semiconductor (for example, a ROM, a nonvolatile memory card, and the like), an optical storage medium (for example, a DVD, a MO, a MD, a CD, a BD, and the like), a magnetic storage medium (for example, a magnetic tape, a flexible disk, and the like), and the like, any one may be possible.

Furthermore, in some cases, the function according to the described systems and methods described above is realized by running the loaded program, and in addition, the function according to the described systems and methods is realized in conjunction with an operating system or other application programs, based on an instruction from the program. Furthermore, in a case where the programs are available on the market, the program stored on a portable recording medium can be distributed or the program can be transmitted to a server computer that connects through a network such as the Internet. In this case, a storage device in the server computer also is included. Furthermore, some or all of the gNB 160 and the UE 102 according to the systems and methods described above may be realized as an LSI that is a typical integrated circuit. Each functional block of the gNB 160 and the UE 102 may be individually built into a chip, and some or all functional blocks may be integrated into a chip. Furthermore, a technique of the integrated circuit is not limited to the LSI, and an integrated circuit for the functional block may be realized with a dedicated circuit or a general-purpose processor. Furthermore, if with advances in a semiconductor technology, a technology of an integrated circuit that substitutes for the LSI appears, it is also possible to use an integrated circuit to which the technology applies.

Moreover, each functional block or various features of the base station device and the terminal device used in each of the aforementioned embodiments may be implemented or executed by a circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller or a state machine. The general-purpose processor or each circuit described above may be configured by a digital circuit or may be configured by an analogue circuit. Further, when a technology of making into an integrated circuit superseding integrated circuits at the present time appears due to advancement of a semiconductor technology, the integrated circuit by this technology is also able to be used.

What is claimed is:

1. A mobile station comprising:
receiving circuitry configured to receive a Radio Resource Control (RRC) message including first information used for configuring a number of repetitions in a time domain for a physical uplink control channel (PUCCH) format 0;
transmitting circuitry configured to transmit uplink control information (UCI) using the PUCCH format 0;
wherein the number of bits supported for the UCI using the PUCCH format 0 is selected from the group consisting of 1 bit and 2 bits;
wherein a low-Peak to Average Power Ratio (low-PAPR) sequence is used for the PUCCH format 0; and,
wherein in a case that the a first number of repetitions has been previously configured, the transmitting circuitry repeatedly transmitting the UCI using the PUCCH format 0 in continuous symbols based on the first number of repetitions.

2. The mobile station of claim 1 wherein the receiving circuitry receives a second information used to enable frequency hopping in a frequency domain for the PUCCH format 0, and in a case that hopping in the frequency is enabled, the transmitting circuitry transmits the UCI using the PUCCH format 0 with hopping in the frequency domain, where the number of repetitions in the time domain is applied per hop in the frequency domain.

3. A base station comprising:
transmitting circuitry configured to transmit a Radio Resource Control (RRC) message including first information used for configuring a number of repetitions in a time domain for a physical uplink control channel (PUCCH) format 0;
receiving circuitry configured to receive uplink control information (UCI) using the PUCCH format 0;
wherein the number of bits supported for the UCI using the PUCCH format 0 is selected from the group consisting of 1 bit and 2 bits;
wherein a low-Peak to Average Power Ratio (low-PAPR) sequence is used for the PUCCH format 0; and,
wherein the receiving circuitry, in a case when a first number of repetitions has been previously configured, repeatedly receives the UCI using the PUCCH format 0 in continuous symbols based on the first number of repetitions.

4. The base station of claim 3 wherein the transmitting circuitry is configured to transmit a RRC message including second information used for enabling hopping in a frequency domain for the PUCCH format 0; and,
wherein the receiving circuitry, in a case when hopping in the frequency is enabled, receives the UCI using the PUCCH format 0 with hopping in the frequency domain, where the number of repetitions in the time domain is applied per hop in the frequency domain.

5. A mobile station communication method comprising:
receiving a Radio Resource Control (RRC) message including first information used for configuring a number of repetitions in a time domain for a physical uplink control channel (PUCCH) format 0;
transmitting uplink control information (UCI) using the PUCCH format 0;
wherein the number of bits supported for the UCI using the PUCCH format 0 is selected from the group consisting of 1 bit and 2 bits;
wherein a low-Peak to Average Power Ratio (low-PAPR) sequence is used for the PUCCH format 0; and,
wherein transmitting the UCI includes, in a case when a first number of repetitions has been previously configured, repeatedly transmitting the UCI using the PUCCH format 0 in continuous symbols based on the first number of repetitions.

6. The method of claim 5 further comprising:
receiving a RRC message including second information used for enabling of a hopping in a frequency domain for the PUCCH format 0;
wherein transmitting the UCI includes, in a case when hopping in the frequency is enabled, transmitting the UCI using the PUCCH format 0 with hopping in the frequency domain, where the number of repetitions in the time domain is applied per hop in the frequency domain.

7. A base station communication method comprising:
transmitting a Radio Resource Control (RRC) message including first information used for configuring a number of repetitions in a time domain for a physical uplink control channel (PUCCH) format 0;
receiving uplink control information (UCI) using the PUCCH format 0;
wherein the number of bits supported for the UCI using the PUCCH format 0 is selected from the group consisting of 1 bit and 2 bits;
wherein a low-Peak to Average Power Ratio (low-PAPR) sequence is used for the PUCCH format 0; and,
wherein receiving the UCI includes, in a case when a first number of repetitions has been previously configured, repeatedly receiving the UCI using the PUCCH format 0 in continuous symbols based on the first number of repetitions.

8. The method of claim 7 further comprising:
transmitting a RRC message including second information used for enabling hopping in a frequency domain for the PUCCH format 0; and,
wherein receiving the UCI includes, in a case when hopping in the frequency is enabled, receiving the UCI using the PUCCH format 0 with hopping in the frequency domain, where the number of repetitions in the time domain is applied per hop in the frequency domain.
